(19) United States
(12) Patent Application Publication
(10) Pub. No.: US 2011/0235716 A1
(43) Pub. Date: Sep. 29, 2011

(54) DECODING APPARATUS, DECODING METHOD, PROGRAM AND INTEGRATED CIRCUIT

(76) Inventors: Takeshi Tanaka, Osaka (JP); Hiroshi Amano, Osaka (JP); Yoshiteru Hayashi, Kyoto (JP); Takashi Hashimoto, Hyogo (JP); Satoshi Kajita, Osaka (JP)

(21) Appl. No.: 13/121,041

(22) PCT Filed: Oct. 7, 2010
(86) PCT No.: PCT/JP2010/006009

§ 371 Date: Mar. 25, 2011

(30) Foreign Application Priority Data
Oct. 19, 2009 (JP) 2009-240902

(51) Int. Cl. H04N 7/26

(52) U.S. Cl. 375/240.16; 375/E07.125

(57) ABSTRACT

A decoding apparatus (100) includes: a first memory unit (20) storing pixel data of a decoded reference image to be referred to in decoding; a second memory unit (30) having a storage capacity smaller than that of the first memory unit (20) and providing a data reading speed faster than that provided by the first memory unit (20); a search area transfer unit (40) transferring, from the first memory unit (20) to the second memory unit (30), pixel data in a search area that is a part of the reference image and required to calculate a motion vector for the block; a motion vector operating unit (50) calculating the motion vector by repeatedly (i) reading out, from the second memory unit (30), the pixel data and (ii) performing a predetermined operation on the pixel data; and a decoding unit (60) decoding the block using the calculated motion vector.

### TECHNICAL FIELD

The present invention relates to image decoding apparatuses which decode coded images and image decoding methods, and in particular to image decoding apparatuses which perform correlation search of decoded images with respect to images to be decoded and image decoding methods performed thereby.

### BACKGROUND ART

An image coding apparatus which codes a moving picture divides each of the pictures making up the moving picture into macroblocks each composed of 16×16 pixels, and codes each picture in units of a macroblock. The image coding apparatus generates a coded stream obtained by compressing and coding the moving picture. An image decoding apparatus decodes this coded stream in units of a macroblock, and reproduces each of the pictures in the original moving picture.

Conventional image coding standards include the ITU-T H.264 Standard (for example, see NPL (Non-patent Literature) 1 and NPL 2. As shown in FIG. 30, an image decoding apparatus conforming to the H.262 Standard first reads out a coded stream from a bitstream buffer 702, performs variable length decoding on the coded stream using a variable length decoding unit 704, and outputs coding information and coefficient information corresponding to each pixel data. Here, coding information includes macroblock types, intra-picture prediction (intra prediction) modes, motion vector information, and quantization parameters. Such coding information is passed to a control unit 701, and is converted to have a format conforming to the processing performed by each processing unit.

Coefficient information is subjected to inverse quantization by an inverse quantization unit 705, and then inverse frequency transform according to the macroblock type by an inverse frequency transform unit 706. In the case where the macroblock type is intra macroblock, an intra prediction unit 707 generates a prediction image according to the intra prediction mode. In the opposite case where the macroblock type is inter macroblock, a motion vector calculating unit 708 calculates a motion vector from motion vector information, and then a motion compensation unit 809 generates a prediction image using the motion vector. Furthermore, a reconstructing unit 711 generates a decoded image from the prediction image and the coefficient information subjected to the inverse frequency transform. The coefficient information is a difference image. Furthermore, a deblocking filter unit 712 performs deblocking filtering on the decoded image, and then the filtered image is stored in a frame memory 703.

The H.264 Standard defines a macroblock type called direct mode. The direct mode is an inter macroblock of a kind. In the direct mode, no motion vector information is included in a coded stream, and a motion vector is generated using a motion vector of a previously decoded picture. FIG. 31 shows a method of calculating a motion vector in the direct mode in the H.264 Standard. Motion vectors mvL0 and mvL1 for a current macroblock to be decoded are calculated by scaling, using time intervals tb and td of the respective reference pictures, the motion vector mvCol of an anchor block that is of each of anchor pictures corresponding to the current picture to be decoded and is co-located with the macroblock to be decoded in the current picture.

The direct mode does not require insertion of motion vector information in a coded stream, and thus provides a high compression efficiency. However, depending on an image, a motion vector that is generated in the direct mode may not be the optimum motion vector. A non-optimum motion vector decreases the amount of motion vector information but increases the amount of coefficient information corresponding to the difference from the prediction image, resulting in a decrease in compression efficiency. Such a non-optimum motion vector often makes a large difference especially in the case where an anchor block is an intra block because of lack of motion vector.

On the other hand, techniques proposed as the next generation image coding standards includes a technique for solving the problem (NPL (Non-patent Literature) 3). As shown in FIG. 32, this technique makes a modification to the method of operating in a direct mode in the conventional H.264 Standard. More specifically, this technique determines a motion vector by detecting the part having the highest correlation, that is, the most similar part within a predetermined range that is of each of two reference pictures L0 and L1 and has the center co-located with a macroblock to be decoded, according to the search method described below.

The aforementioned search method is for performing search symmetrically in every directions with respect to, as a center in the search, the position of the macroblock to be decoded. First, a SAD (sum of absolute differences) is calculated by comparison between the pixels in the top left position of the search area in the reference picture L0 and the pixels in the bottom right position of the search area in the reference picture L1. Next, SADs are sequentially calculated by shifting to the right in the reference picture L0, and shifting to the left in the reference picture L1.

In this way, SADs are sequentially calculated, and the position that yields the smallest SAD is regarded as the most similar position. The vector is converted into motion vectors mvL0 and mwL1 starting from the decoded macroblock of the decoded picture. Calculating a motion vector by using a raw reference image in this way makes it possible to always calculate the optimum motion vector because no information at the time of previous decoding is used as in conventional techniques. This prevents increase in the amount of coefficient information, and eliminates the need to insert motion vector information into a coded stream, and thereby makes it possible to increase the compression efficiency.

In the H.264 Standard, the same motion vector calculation in the direct mode is performed also in skip mode for a B-picture. In this DESCRIPTION, the skip mode is included within the scope of the direct mode.

### CITATION LIST

### Patent Literature

### Patent Literature

### [PTL 1]

ITU-T H.264 Specifications, Advanced video coding for generic audiovisual services, issued in March, 2005

### Non Patent Literature

### [NPL 2]

Thomas Wiegand et al., “Overview of the H.264/AVC Video Coding Standard”, IEEE TRANSACTIONS ON CIRCUITS AND SYSTEMS FOR VIDEO TECHNOLOGY, July, 2003, PP. 1-19

### [NPL 3]

Tomokazu Murakami, “Advanced B Skip Mode with Decoder-side Motion Estimation”, [online], ITU-T Video Coding Experts Group, Apr. 15, 2009, [Search on Sep. 18, 2009], Internet URL: <http://wftp3.itu.int/av-arch/video-site/0904_Yok/VCEG-AK12.zip>

### SUMMARY OF INVENTION

### Technical Problem

As described above, NPL 3 shows an operation method for determining a motion vector by searching reference images in the direct mode. However, NPL 3 does not specifically show a mechanism for performing a motion vector search by using a reference image having an extremely large amount of data compared in the case of conventional motion vector calculation and obtaining a necessary reference image from a frame memory.

In the conventional direct mode, data used in motion vector calculation is a motion vector of a previous picture, and the data amount of a single motion vector is as small as 4 Bytes. In contrast, the method disclosed in NPL 3 uses a raw image stored in a frame memory, and thus requires, for each search, the data of at least 512 pixels, that is presented as 16×16 pixels multiplied by two pictures, and also requires 17×17 pixels=289 times of motion vector searches in the case of a 32×32 pixel search area. Accordingly, NPL 3 needs to read out data of 512×289=147, 968 Bytes from the frame memory to calculate a motion vector in the direct mode. The data amount is approximately 40 thousand times larger than in the conventional method. Furthermore, in the case of a high resolution video, the number of macroblocks per second is 244,800, and thus the amount of data transferred from the frame memory is huge. The transfer amount per second corresponds to 36 GBytes/sec when represented as the band width indicating the transfer amount per second.

The processing performance is determined largely dependent on both the operation performance and data transfer performance. Thus, time-consuming transfer of necessary data degrades the processing performance even when high-speed calculation is possible.

In general, a frame memory in an image decoding apparatus has a large capacity, and is often placed in a DRAM (dynamic random access memory) that is connected from outside an LSI (large scale integration) which performs such operation. However, it is extremely difficult and/or costly to configure such a DRAM that requires a large band width for data transfer as mentioned above. However, a normal DRAM does not have a sufficient transfer performance, and results in degradation in the processing performance. In order to achieve a high performance, it is necessary to reduce the amount of data to be transferred from a frame memory and reduce the bandwidth required to transfer the data.

The present invention has been conceived to solve the above-described problems, and aims to provide an image decoding apparatus capable of reducing the amount of data to be transferred from a frame memory and reducing the bandwidth required to transfer the data in motion vector calculation.

### Solution to Problem

A decoding apparatus according to an aspect of the present invention decodes a block included in a coded image. More specifically, the decoding apparatus includes: a first memory unit configured to store pixel data of a reference image that is an image already decoded by the decoding apparatus and is referred to when the block is decoded; a second memory unit which has a storage capacity smaller than a storage capacity of the first memory unit and provides a data reading speed faster than data reading speed provided by the first memory unit; a search area transfer unit configured to transfer, from the first memory unit to the second memory unit, pixel data in a search area that is a part of the reference image and required to calculate a motion vector for the block; a motion vector operating unit configured to calculate the motion vector for the block by repeatedly (i) reading out, from the second memory unit, the pixel data in the search area for the block and (ii) performing a predetermined operation on the pixel data; and a decoding unit configured to decode the block using the motion vector calculated by the motion vector operating unit.

With this structure, it is possible to calculate the motion vectors using the read out pixel data by transferring, only once in advance, the pixel data in the search areas from the first memory unit to the second memory unit and repeatedly reading out the pixel data in the search areas from the second memory unit that is for fast data reading. As a result, it is possible to reduce both the amount of data to be transferred from the first memory unit and the amount of electric power required for the data transfer. It is to be noted that a “block” in this DESCRIPTION is typically referred to as a macroblock, but is not limited thereto.

As an aspect, the block may be either a first block coded without adding information indicating a motion vector to be used in decoding or a second block coded by adding information indicating a motion vector. The search area transfer unit may be configured to transfer the pixel data in the search area from the first memory unit to the second memory unit, only when the block to be decoded is the first block. The decoding unit may be configured to decode the first block by using the motion vector calculated by the motion vector operating unit, and decode the second block using the added motion vector. In this way, it is possible to minimize the amount of data to be transferred from the first memory unit to the second memory unit. As a result, it is possible to further reduce the amount of electric power required for the data transfer.

As another aspect, the block may be either a first block coded without adding information indicating a motion vector to be used in decoding or a second block coded by adding information indicating a motion vector. The search area transfer unit may be configured to start transferring the pixel data in the search area from the first memory unit to the second memory unit, before determining whether the block to be decoded is the first block or the second block. The decoding unit may be configured to decode the first block by using the motion vector calculated by the motion vector operating unit, and decode the second block by using the added motion vector. In this way, it is possible to reduce a waiting time necessary for the motion vector calculating unit to wait completion of the transfer of the pixel data in the search area.

Alternatively, the search area transfer unit may be configured to stop transfer of the pixel data in the search area from the first memory unit to the second memory unit, when the block to be decoded is the second block. In this way, the amount of data to be transferred is reduced by the amount of unnecessary data, which makes it possible to further reduce the amount of electric power required for the data transfer.

In addition, the second memory unit may be configured to keep storing at least a part of previous pixel data transferred by the search area transfer unit. The search area transfer unit may be configured to transfer only pixel data that has not yet been stored in the second memory unit among the pixel data in the search area, from the first memory unit to the second memory unit. In this way, it is possible to further reduce the amount of data to be transferred from the first memory unit.

Furthermore, the search area transfer unit may be configured to delete, from the second memory unit, pixel data that is not used to calculate motion vectors for following blocks that make up the coded image from among previous pixel data. In this way, it is possible to reduce the storage capacity of the second memory unit.

As an aspect, in the case where blocks that make up the coded image are sequentially decoded from top left to bottom right of the coded image, the search area transfer unit in a decoding apparatus may be configured to transfer pixel data in a part corresponding to a bottom right corner of the search area from the first memory unit to the second memory unit, and delete, from the second memory unit, pixel data transferred before pixel data in a part corresponding to a top left corner of the search area is transferred.

Alternatively, the search area transfer unit may be configured to transfer pixel data in the search area corresponding to an (n+1)th block from the first memory unit to the second memory unit, in parallel with calculation of a motion vector of an nth block by the motion vector operating unit, n being a natural number, and the nth block and the (n+1)th block being included in blocks that make up the coded image. In this way, performing processes required for decoding in pipeline processing eliminates idle time for data transfer, which makes it possible to further reduce the band width for transfer from the first memory unit.

The decoding apparatus may further include: a motion compensation operating unit configured to generate a prediction image for the block by using the motion vector and the pixel data in the reference image; a third memory unit configured to store pixel data of a reference area that is a part of the reference image and is referred to by the motion compensation operating unit; and a reference area transfer unit configured to transfer the pixel data in the reference area from one of the first and second memory units to the third memory unit. In this way, it is possible to further reduce the amount of data to be transferred from the first memory unit.

As an aspect, the block may be either a first block coded without adding information indicating a motion vector to be used in decoding or a second block coded by adding information indicating a motion vector. The reference area transfer unit may be configured to transfer pixel data in the reference area corresponding to the first block from the second memory unit to the third memory unit, and transfer pixel data in the reference image corresponding to the second block from the first memory unit to the third memory unit. In the direct mode, a search area is substantially the same as a reference area. Thus, it is possible to transfer the pixel data in the reference area from the second memory unit to the third memory unit. Pixel data may be transferred from the second memory unit irrespective of whether the mode in use is the direct mode, when the pixel data of the reference area is stored in the second memory unit or not is determined and the determination is affirmative.

In addition, the second memory unit may include: a search area memory unit that is directly accessed by the motion vector operating unit; and a wide area memory unit configured to store pixel data of an area that includes the search area stored in the search area memory unit and is wider than the search area in the reference image. The reference area transfer unit may be configured to transfer pixel data in the reference area from the wide area memory unit to the third memory unit. In this way, it is possible to reduce both the storage capacity of the search area memory unit and the number of accesses to the search area memory unit.

In addition, the search area may include: a first search area included in a preceding reference image that precedes, in display order, the coded image including the block; and a second search area included in a succeeding reference image that succeeds, in display order, the coded image including the block. The motion vector operating unit may be configured to: repeatedly perform (i) reading out, from the second memory unit, pixel data in a search range in each of the first and second search areas, and (ii) calculating a sum of absolute differences, the (i) reading and (ii) calculating being performed by shifting a position of the search range within each of the first and second search areas; and calculate the motion vector, based on the position that is of the search range and has a smallest sum of absolute differences. Here, methods of calculating a motion vector is not limited thereto.

A decoding method according to an aspect of the present invention is of decoding a block included in a coded image. The decoding method is performed by a decoding apparatus including: a first memory unit configured to store pixel data of a reference image that is an image already decoded by the decoding apparatus and is referred to when the block is decoded; and a second memory unit which has a storage capacity smaller than a storage capacity of the first memory unit and provides a data reading speed faster than data reading speed provided by the first memory unit. More specifically, the decoding method includes: transferring, from the first memory unit to the second memory unit, pixel data in a search area that is a part of the reference image and required to calculate a motion vector for the block; calculating the motion vector for the block by repeatedly (i) reading out, from the second memory unit, the pixel data in the search area for the block and (ii) performing a predetermined operation on the pixel data; and decoding the block using the motion vector calculated in the calculating.

A program according to an aspect of the present invention causes a decoding apparatus to decode a block included in a coded image. The decoding apparatus includes: a first memory unit configured to store pixel data of a reference image that is an image already decoded by the decoding apparatus and is referred to when the block is decoded; and a second memory unit which has a storage capacity smaller than a storage capacity of the first memory unit and provides a data reading speed faster than data reading speed provided by the first memory unit. More specifically, the program causes the decoding apparatus to execute: transferring, from the first memory unit to the second memory unit, pixel data in a search area that is a part of the reference image and required to calculate a motion vector for the block; calculating the motion vector for the block by repeatedly (i) reading out, from the second memory unit, the pixel data in the search area for the block and (ii) performing a predetermined operation on the pixel data; and decoding the block using the motion vector calculated in the calculating.

An integrated circuit according to an aspect of the present invention decodes a block included in a coded image. The integrated circuit is included in a decoding apparatus which includes a first memory unit configured to store pixel data of a reference image that is an image already decoded by the decoding apparatus and is referred to when the block is decoded. More specifically, the integrated circuit includes: a second memory unit which has a storage capacity smaller than a storage capacity of the first memory unit and provides a data reading speed faster than data reading speed provided by the first memory unit; a search area transfer unit configured to transfer, from the first memory unit to the second memory unit, pixel data in a search area that is a part of the reference image and required to calculate a motion vector for the block; a motion vector operating unit configured to calculate the motion vector for the block by repeatedly (i) reading out, from the second memory unit, the pixel data in the search area for the block and (ii) performing a predetermined operation on the pixel data; and a decoding unit configured to decode the block using the motion vector calculated by the motion vector operating unit.

### Advantageous Effects of Invention

The present invention provides an advantageous effect of making it possible to implement a decoding apparatus capable of reducing either the amount of data to be transferred from the first memory unit or the band width required for the data transfer.

### BRIEF DESCRIPTION OF DRAWINGS

FIG. 1A is a block diagram showing a schematic structure of an image decoding apparatus.

FIG. 1B is a block diagram showing a detailed structure of an image decoding apparatus.

FIG. 2 is an illustration showing a flow of operations performed by the image decoding apparatus.

FIG. 3A is an illustration showing time-series operations performed by the image decoding apparatus in the case of a non-inter macroblock.

FIG. 3B is an illustration showing time-series operations performed by the image decoding apparatus in the case of a non-direct mode inter macroblock.

FIG. 3C is an illustration showing time-series operations performed by the image decoding apparatus in the case of a direct mode.

FIG. 4 is a block diagram showing a structure of the image decoding apparatus.

FIG. 5 is an illustration showing a flow of operations performed by the image decoding apparatus.

FIG. 6 is an illustration showing time-series operations performed by the image decoding apparatus.

FIG. 7A is a diagram showing a search area in a macroblock MBn.

FIG. 7B is a diagram showing a search area in a macroblock MBn+1 next to the macroblock MBn.

FIG. 7C is a diagram of an enlarged view of search areas in the macroblock MBn and the macroblock MBn+1.

FIG. 8A is a diagram showing a search area in a macroblock MBn.

FIG. 8B is a diagram showing a search area in a macroblock MBn+8 immediately below the macroblock MBn.

FIG. 8C is a diagram of an enlarged view of search areas in the macroblock MBn and the macroblock MBn+8.

FIG. 8D is a diagram showing an area that is of a reference image and is stored in a search image memory.

FIG. 9 is an illustration showing a flow of operations performed by the image decoding apparatus.

FIG. 10 is an illustration showing time-series operations performed by the image decoding apparatus.

FIG. 11 is an illustration showing operations performed by the image decoding apparatus.

FIG. 12 is a block diagram showing a structure of the image decoding apparatus.

FIG. 13 is an illustration showing a flow of operations performed by the image decoding apparatus.

FIG. 14 is an illustration showing time-series operations performed by the image decoding apparatus.

FIG. 15 is a block diagram showing a structure of the image decoding apparatus.

FIG. 16 is an illustration showing a flow of a reference image transfer operation performed by the image decoding apparatus.

FIG. 17 is a block diagram showing a structure of the image decoding apparatus.

FIG. 18 is an illustration showing a flow of a reference image transfer operation performed by the image decoding apparatus.

FIG. 19 is a block diagram showing a structure of the image decoding apparatus.

FIG. 20 is an illustration showing a flow of a search image transfer operation performed by the image decoding apparatus.

FIG. 21A is a diagram showing an area that is of a reference image and is stored in a wide area memory unit.

FIG. 21B is a diagram showing an area that is of a reference image and is stored in a search area memory unit.

FIG. 22 is an illustration showing a flow of a reference image transfer operation performed by the image decoding apparatus.

FIG. 23 schematically shows an overall configuration of a content providing system for implementing content distribution services.

FIG. 24 schematically shows an example of an overall configuration of a digital broadcasting system.

FIG. 25 is a block diagram showing an example of a configuration of a television.

FIG. 26 is a block diagram showing an example of a configuration of an information reproducing and recording unit that reads and writes information from and on a recording medium that is an optical disk.

FIG. 27 shows an example of a configuration of a recording medium that is an optical disk.

FIG. 28 is a block diagram showing the image decoding processing performed by an integrated circuit in each of the embodiments.

FIG. 29 is a block diagram showing the image decoding processing performed by an integrated circuit in each of the embodiments.

FIG. 30 is a block diagram of a conventional image decoding apparatus.

FIG. 31 is an illustration showing an operation method in a direct mode according to the conventional H.264 Standard.

FIG. 32 is an illustration showing a conventional operation method for obtaining a motion vector by searching reference images in the direct mode.

### DESCRIPTION OF EMBODIMENTS

Image decoding apparatuses according to embodiments of the present invention are described with reference to the drawings.

### Embodiment 1

An image decoding apparatus according to Embodiment 1 of the present invention is schematically described. The image decoding apparatus according to Embodiment 1 of the present invention performs variable length decoding on a coded stream (coded image) in units of a macroblock that constitute a part of the coded image. Next, in the case where a current macroblock is a direct mode, the image decoding apparatus reads out the pixel data in a search area (also referred to as “search image”) in a reference image, and stores the pixel data of a search image memory. The image decoding apparatus is configured to determine a motion vector by repeatedly reading out, for each macroblock, the pixel data in the search area from the search image memory and performing a predetermined operation on the pixel data.

This is the outline of the image decoding apparatus according to the present invention.

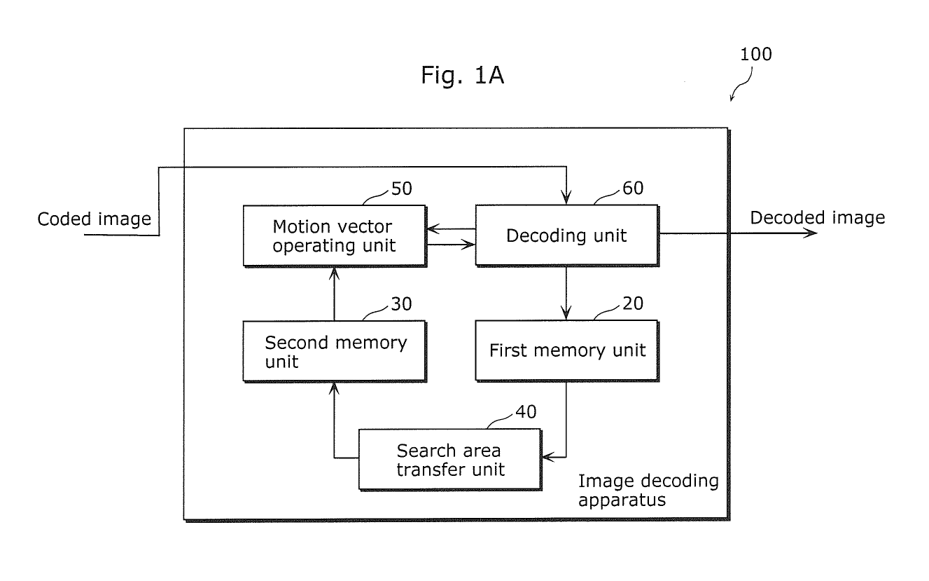

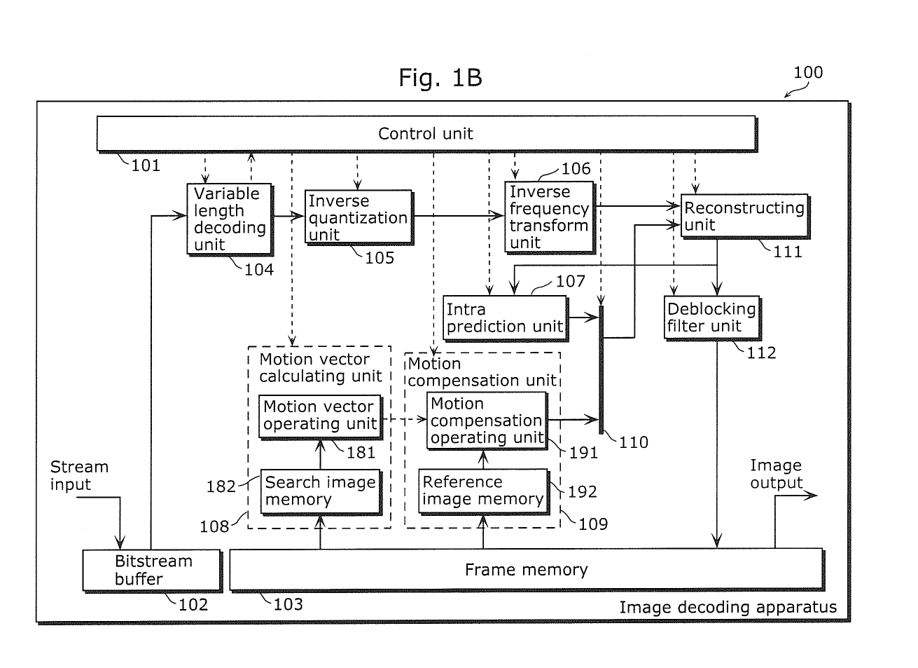

Next, the structure of the image decoding apparatus 100 in Embodiment 1 is described with reference to FIGS. 1A and 1B. FIG. 1A is a block diagram showing a schematic structure of the image decoding apparatus 100 in Embodiment 1. FIG. 1B is a block diagram showing a schematic structure of the image decoding apparatus 100 in Embodiment 1.

As shown in FIG. 1A, the image decoding apparatus 100 includes: a first memory unit 20, a second memory unit 30, a search area transfer unit 40, a motion vector operating unit 50, and a decoding unit 60. The image decoding apparatus 100 decodes a coded image in units of a macroblock, and outputs the decoded image. It is to be noted that the following describes an example of performing decoding in units of a macroblock, but the present invention is not limited thereto. More specifically, the image decoding apparatus 100 is capable of performing decoding in units a block that has an arbitrary size larger or smaller than a macroblock.

The first memory unit 20 stores pixel data of a reference image that is an image already decoded by the image decoding apparatus 100 and is referred to when a macroblock is decoded. The second memory unit 30 is a memory unit which has a storage capacity smaller than that of the first memory unit 20 and is for reading of data faster than reading of data from the first memory unit 20. Typically, the first memory unit 20 is a DRAM (dynamic random access memory), and the second memory unit 30 is a SRAM (static random access memory), but storages for use here are not limited thereto.

The search area transfer unit 40 transfers pixel data that is of a part of the reference image and is required to calculate a motion vector for the macroblock, from the first memory unit 20 to the second memory unit 30. The motion vector operating unit 50 calculates a motion vector for the macroblock by repeatedly reading out, for each macroblock, the pixel data in a search area from the second memory unit 30 and performing a predetermined operation on the pixel data. The decoding unit 60 decodes the macroblock by using the motion vector calculated by the motion vector operating unit 50.

As shown in FIG. 1B, the image decoding apparatus 100 in Embodiment 1 includes: a control unit 101 which controls the whole apparatus; a bitstream buffer 102 which stores an input coded stream; a frame memory 103 which stores decoded image data; a variable length decoding unit 104 which reads out the coded stream and performs variable length decoding on the coded stream; an inverse quantization unit 105 which performs inverse quantization; an inverse frequency transform unit 106 which performs inverse frequency transform; an intra prediction unit 107 which generates a prediction image by performing an intra-picture prediction (also referred to as intra prediction); a motion vector calculating unit 108 which calculates a motion vector; a motion compensation unit 109 which performs motion compensation to generate a prediction image; a switch 110 which switches prediction images; a reconstructing unit 111 which generates a decoded image from the inversely transformed difference image and prediction image; and a deblocking filter unit 112 which removes block noise in the reconstructed image to enhance the image quality.

The motion vector calculating unit 108 further includes: a motion vector operating unit 181 which performs motion vector operation; and a search image memory 182 which stores pixel data of a search area (also referred to as “search image”) required to calculate a motion vector. The motion compensation unit 109 includes: a motion compensation operating unit 191 which performs motion compensation operation; and a reference image memory 192 which stores pixel data of a reference area (also referred to as “reference image”) used in motion compensation.

Here, the first memory unit 20 in FIG. 1A corresponds to the frame memory 103 in FIG. 1B. The second memory unit 30 in FIG. 1A corresponds to the search image memory 182 in FIG. 1B. The search area transfer unit 40 in FIG. 1A is included in the motion vector calculating unit 108 although the search area transfer unit 40 is not shown in FIG. 1B. The motion vector operating unit 50 in FIG. 1A corresponds to the motion vector operating unit 181 in FIG. 1B. The decoding unit 60 in FIG. 1A corresponds to the variable length decoding unit 104, the inverse quantization unit 105, the inverse frequency transform unit 106, the reconstructing unit 111, etc.

The structure of the image decoding apparatus 100 has been described above.

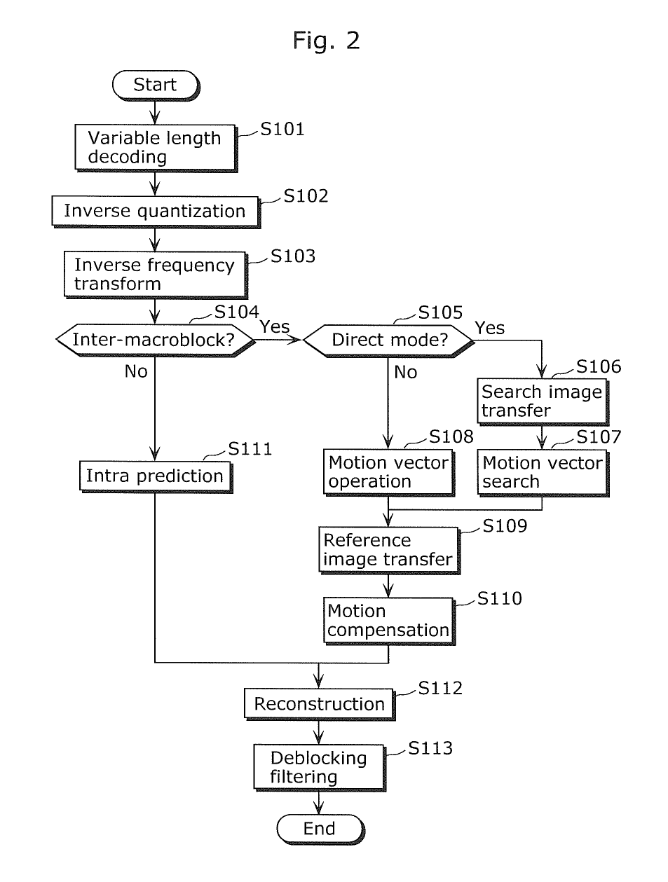

Next, the operations performed by the image decoding apparatus 100 shown in FIGS. 1A and 1B are described with reference to the flowchart in FIG. 2. FIG. 2 shows a decoding operation performed on a single macroblock. In Embodiment 1, processing performed on processing targets other than direct-mode targets is the same as processing in the H.264 Standard, and the operation method shown in NPL 3 is employed for the direct-mode targets.

First, the variable length decoding unit 104 performs variable length decoding on an input coded stream (S101). The variable length decoding unit 104 outputs coding information and coefficient information. The coding information includes macroblock types, intra-picture prediction (intra prediction) mode, motion vector information, and quantization parameters, and the coefficient information corresponds to each pixel data. The coding information is output to the control unit 101, and then input to each processing unit. The coefficient information is output to the inverse quantization unit 105. Next, the inverse quantization unit 105 performs inverse quantization (S102). Next, the inverse frequency transform unit 106 performs inverse frequency transform (S103).

Next, whether a current macroblock to be decoded is an inter macroblock or an intra macroblock is determined (S104). When the current macroblock is an inter macroblock (Yes in S104), whether the inter macroblock is a direct mode or not is determined (S105). More specifically, whether the current macroblock is a first block coded without adding information indicating a motion vector for use in decoding or a second bock coded by adding information indicating a motion vector.

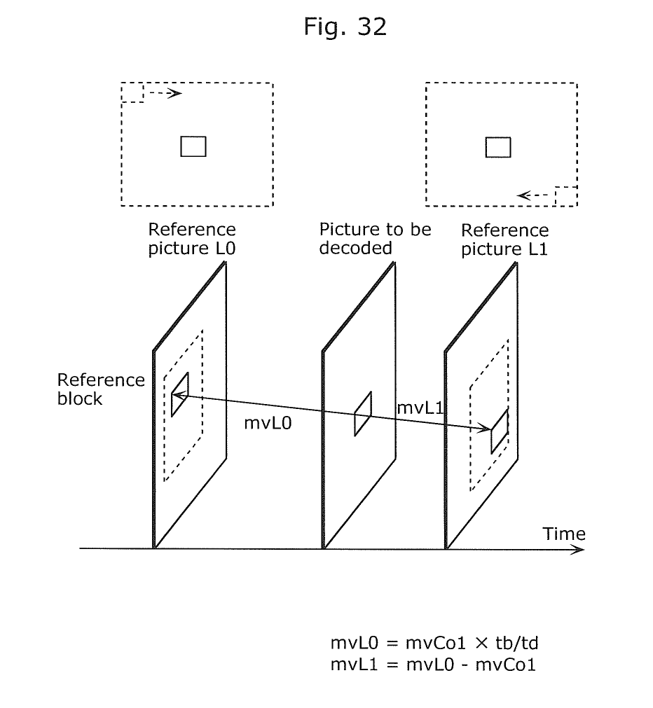

When the current macroblock is a direct mode (Yes in S105), the pixel data in the search area for motion vector search is transferred from the frame memory 103 to the search image memory 182 (S106). As shown in FIG. 32, when the search area corresponds to 32×32 pixels, the position of the search area in each of two reference images corresponds to 32×32 pixels composed of the decoded macroblock and parts of the respective adjacent macroblocks. When the top left pixel of the decoded macroblock is represented as (x, y) in two-dimensional coordinates, the 32×32 pixel area having the top left pixel at (x−8, y−8) is the search area. More specifically, the search area in the reference image includes the area co-located with the area of a current macroblock to be decoded in a decoding target image, and is larger than the current macroblock.

Next, a motion vector is calculated by causing the motion vector operating unit 181 to search a motion vector by using the pixel data in the search area stored in the search image memory 182 (S107). The following describes an example of how to perform motion vector search.

First, as shown in FIG. 32, in the case of two reference pictures L0 and L1 stored in the search image memory 182, the pixels in the top left position in the search area in the reference picture L0 and the pixels in the bottom right position in the search area in the reference picture L1 are compared with each other to calculate a SAD (sum of absolute differences). Next, SADs are sequentially calculated by shifting to the right in the reference picture L0, and shifting to the left in the reference picture L1. In this way, SADs are sequentially calculated, and the position that yields the smallest SAD is regarded as the most similar position. The vector is converted into motion vectors mvL0 and mwL1 starting from the decoded macroblock of the decoded picture.

More specifically, the search image memory 182 stores pixel data of a first search area (shown by broken lines) included in the reference picture L0 that precedes in display order the coded image including the current macroblock to be decoded and pixel data in a second search area (shown by broken lines) included in the reference picture L1 that succeeds in display order the coded image including the current macroblock to be decoded.

The motion vector operating unit 181 first reads out, from the search image memory 182, the pixel data of the top left block (search range) in the first search area in the reference picture L0 and the pixel data in the bottom right block (search range) in the second search area in the reference picture L1, and calculates the SADs between the pixel data of these two blocks. The blocks to be read out are the same in size as the current macroblock to be decoded.

Next, the motion vector operating unit 181 repeatedly executes the above-described processes, for each target, while shifting the search range within the first and second search areas. Next, the motion vector operating unit 181 calculates a motion vector, based on the pixel that is in the search range and yields the smallest SAD.

In the case where the current macroblock is not a direct mode (No in S105), the motion vector operating unit 181 performs motion vector operation to calculate a motion vector (S108). The H.264 Standard defines, when adjacent motion vectors are mvA, mvB, and mvC, the median value of these vectors is the prediction motion vector. A motion vector is calculated by adding this prediction motion vector and motion vector information (the difference value of the motion vector) included in the coded stream.

The motion vector obtained here is output to the motion compensation unit 109. Next, the pixel data in the reference area (also referred to as “reference image”) indicated by the motion vector is transferred from the frame memory 103 to the reference image memory 192 (S109). Next, the motion compensation operating unit 191 generates prediction images at ½ pixel accuracy or ¼ pixel accuracy, by using the pixel data in the reference area stored in the reference image memory 192.

On the other hand, in the case where the current macroblock is not an inter macroblock but an intra macroblock (No in S104), the intra prediction unit 107 performs intra prediction to generate a prediction image (S111). In the structural diagram of FIG. 1B, whether or not the current macroblock is an inter macroblock is selected by the switch 110.

The reconstructing unit 111 adds the resulting prediction image and the difference image output by the inverse frequency transform unit 106 to generate a decoded image (S112). Next, the deblocking filter unit 112 performs deblocking filtering for reducing blocking noise on the decoded image, and stores the outcome in the frame memory 103 (S113).

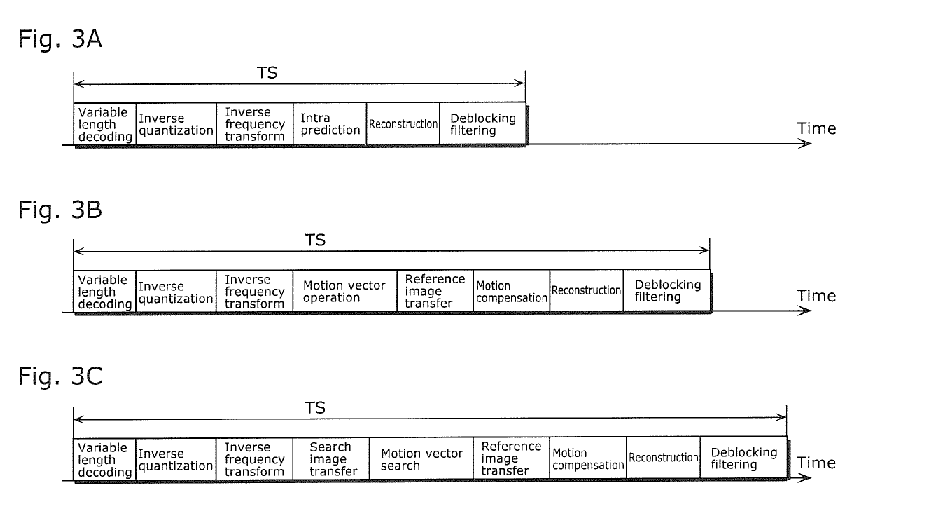

Each of FIG. 3A to FIG. 3C shows these time-series operations. FIGS. 3A, 3B, and 3C show a case of a non-inter macroblock, a case of a non-direct mode inter macroblock, and a case of a direct mode, respectively. In either case, the operations are sequentially performed according to the order of processes shown in FIG. 2. A TS (time slot) in each diagram shows time required to decode a single macroblock, and the time may vary depending on macroblocks.

In Embodiment 1, the direct mode and the non-direct mode are provided as two types of inter macroblocks for the following reasons. The direct mode does not require that information relating to a motion vector is coded in a coded stream, and thus is an excellent method for increasing the compression rate. However, motion vectors are generated at the decoder side, and thus the values of motion vectors may not be optimum depending on the types of images. A non-optimum motion vector increases the amount of codes of coefficient information in the coded stream, resulting in a decrease in the compression rate. For this reason, provision of the two modes that are the direct mode and the non-direct mode makes it possible to select one of the modes that allows the encoder side to perform coding at a higher compression rate. As a result, it is possible to increase the compression rate.

The operations performed by the image decoding apparatus 100 have been described above.

As described above, in Embodiment 1, it is possible to reduce the amount of data to be transferred from the frame memory 103 by providing a conventional motion vector calculating unit with the search image memory 182 for performing motion vector search. Transferring, in advance, the pixel data in the search area to the search image memory 182 prior to the motion vector search eliminates the need to access to the frame memory 103 for each of the operations in motion vector search. In this case, a single access to the search image memory 182 is necessary. As a result, it is possible to reduce the amount of data to be read out from the frame memory 103 to 32×32×2=2048 Bytes per macroblock.

In addition, reducing the transfer amount makes it possible to reduce the amount of electric power required for the transfer.

It is to be noted that variable length coding in Embodiment 1 may be any other coding methods such as Huffman coding and run-length coding, arithmetic coding, and the like.

The direct mode used in Embodiment 1 includes skip mode etc. that substantially uses the direct mode.

In Embodiment 1, the processing performed on processing targets other than direct-mode targets is the same as processing in the H.264 Standard, but other image coding standards such as the MPEG-2 Standard, the MPEG-4 Standard, the VC-1 Standard, and the like are possible. Alternatively, any other method is possible as long as the method supports plural direct modes and one of these is for calculating a motion vector by using pixel data of a reference image stored in a frame memory as shown in NPL 3 cited in Embodiment 1.

Although the method of NPL 3 is used in Embodiment 1, any other method is possible as long as the method is for calculating a motion vector by using pixel data of a reference image stored in a frame memory. Motion vector search ranges and accuracies are not limited to those in Embodiment 1, and may be determined freely. In the case where adjacent pixels are also required to calculate the sub-pixel accuracy positions when motion vector search is performed, the data of the required pixels may be stored in the search image memory 182.

Each of the processing units may be implemented as a circuit by exclusive hardware, or as a program on a processor.

The search image memory 182 and the reference image memory 192 are memories, but any other data storage elements such as flip-flops are possible. Alternatively, the search image memory 182 and the reference image memory 192 may be configured as parts of a memory area in a processor or as parts of a cache memory.

### Embodiment 2

Next, an image decoding apparatus according to Embodiment of the present invention is schematically described. In Embodiment 1, a search image is transferred after inverse frequency transform, only in the case of a direct mode. For this reason, a useless waiting time is produced because a motion vector search process must be performed after the transfer of the search image is completed. In view of this, in Embodiment 2, a motion vector calculating unit further includes a search image transfer unit (search area transfer unit). With this, it is possible to eliminate such a waiting time by starting the transfer of a search image before starting a motion vector calculation process. As a result, it is possible to increase the processing performance and reduce the band width required for transfer from a frame memory.

The outline of the image decoding apparatus in Embodiment 2 has been described above.

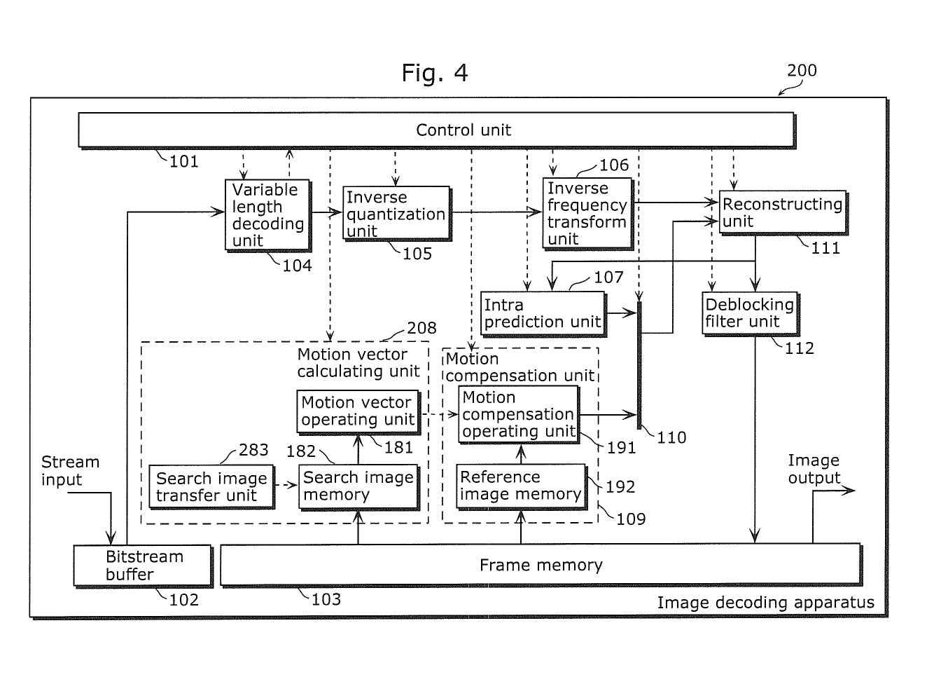

Next, the structure of the image decoding apparatus 200 in Embodiment 2 is described. FIG. 4 is a diagram showing a structure of the image decoding apparatus 200 in Embodiment 2. The image decoding apparatus 200 in Embodiment 2 includes a search image transfer unit 283 which controls data transfer from a frame memory 103 to a search image memory 182. The other structural elements of the image decoding apparatus 200 are the same as those in FIG. 1B in Embodiment 1. Thus, the same structural elements are assigned with the same reference signs, and no descriptions thereof are repeated.

The structure of the image decoding apparatus 200 has been described above.

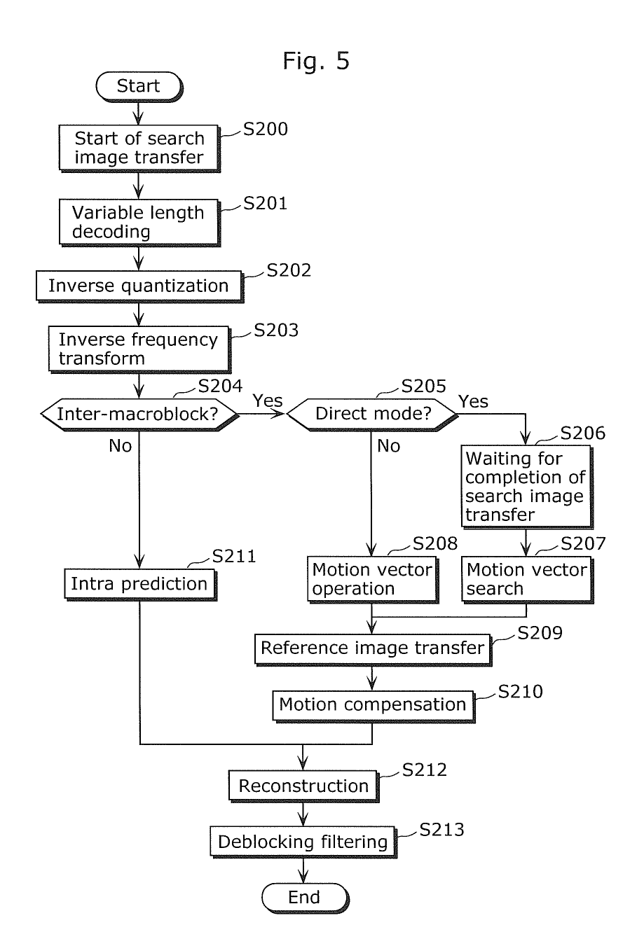

Next, the operations performed by the image decoding apparatus 200 shown in FIG. 4 are described with reference to the flowchart in FIG. 4. FIG. 5 shows a decoding operation performed on a single macroblock. In Embodiment 2, processing performed on processing targets other than direct-mode targets is the same as processing in the H.264 Standard as in Embodiment 1, and the operation method shown in NPL 3 is employed for the direct-mode targets.

First, the search image transfer unit 283 starts transferring the pixel data in the search area to be used for a motion vector search in the direct mode from the frame memory 103 to the search image memory 182 (S200). As shown in FIG. 32, in the case where the search area corresponds to 32×32 pixels, the position of the search area of each of two reference images corresponds to 32×32 pixels that are composed of the decoded macroblock and parts of the respective adjacent macroblocks. When the top left position of the decoded macroblock is represented as (x, y) in two-dimensional coordinates, the search area is the area of 32×32 pixels having the top left pixel at the position of (x−8, y−8).

Here, the transfer needs not to be completed. The search image transfer can be started mainly because the motion vector search in NPL 3 searches a search area of 32×32 pixels that has, as a center, the spatial position co-located with a current macroblock to be decoded as shown in FIG. 32. In this way, the search area is uniquely determined before the variable length decoding unit 104 performs variable length decoding to decode coding information and coefficient information included in a coded stream (that is, before a determination as to whether a current block is a direct mode or not is made). This makes it possible to transfer the pixel data in the search area.

Next, the variable length decoding unit 104 performs variable length decoding on an input coded stream (S201). The variable length decoding unit 104 outputs coding information and coefficient information. The coding information includes macroblock types, intra-picture prediction (intra prediction) mode, motion vector information, and quantization parameters, and the coefficient information corresponds to each pixel data. The coding information is output to the control unit 101, and then input to each processing unit. The coefficient information is output to an inverse quantization unit 105 next. Next, the inverse quantization unit 105 performs inverse quantization (S202). Next, the inverse frequency transform unit 106 performs inverse frequency transform (S203).

Next, whether a current macroblock to be decoded is an inter macroblock or an intra macroblock is determined (S204). When the current macroblock is an inter macroblock (Yes in S204), whether the inter macroblock is a direct mode or not is determined (S205).

When the current macroblock is a direct mode (Yes in S205), a check is made as to whether or not the transfer of the search image is completed by the search image transfer unit 283, and if not, the completion of the transfer is waited (S206). When the transfer is completed, a motion vector is calculated by causing the motion vector operating unit 181 to search a motion vector by using the search image stored in the search image memory 182 (S207).

As shown in FIG. 32, in the case of two reference pictures L0 and L1 stored in the search image memory 182, first, the pixels in the top left position in the search area in the reference picture L0 and the pixels in the bottom right position in the search area in the reference picture L1 are compared with each other to calculate the SADs. Next, SADs are sequentially calculated by shifting to the right in the reference picture L0, and shifting to the left in the reference picture L1. In this way, SADs are sequentially calculated, and the position that yields the smallest SAD is regarded as the most similar position. The vector is converted into motion vectors mvL0 and mwL1 starting from the decoded macroblock to be decoded of the decoded picture.

When the current macroblock is not a direct mode (No in S205), the motion vector operating unit 181 performs motion vector operation to calculate a motion vector (S208). The H.264 Standard defines, when adjacent motion vectors are mvA, mvB, and mvC, the median value of these vectors is the prediction motion vector. A motion vector is calculated by adding this prediction motion vector and motion vector information (the difference value of the motion vector) included in the coded stream.

It is known here that the search image is not used. Thus, it is possible either to wait until the search image transfer unit 283 completes the transfer of the search image, or to stop the transfer if the transfer has not yet been completed. The obtained motion vector is output to the motion compensation unit 109, and the reference image indicated by the motion vector is transferred from the frame memory 103 to the reference image memory 192 (S209). Next, the motion compensation operating unit 191 generates prediction images at ½ pixel accuracy or ¼ pixel accuracy, by using the reference image stored in the reference image memory 192 (S210).

On the other hand, in the case where the current macroblock is not an inter macroblock (No in S204) and thus is an intra macroblock, the intra prediction unit 107 performs intra prediction to generate a prediction image (S211). It is also known here that the search image is not used. Thus, it is possible either to wait until the search image transfer unit 283 completes the transfer of the search image, or to stop the transfer if the transfer has not yet been completed. In the structural diagram of FIG. 4, whether or not the current macroblock is an inter macroblock is selected by the switch 110.

The reconstructing unit 111 adds the resulting prediction image and the difference image output by the inverse frequency transform unit 106 to generate a decoded image (S212). Next, the deblocking filter unit 112 performs deblocking filtering for reducing blocking noise on the decoded image, and stores the outcome in the frame memory 103 (S213).

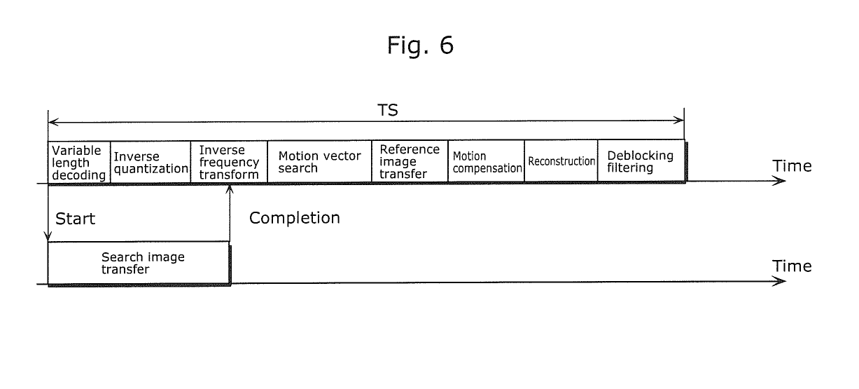

FIG. 6 shows time-series operations in the direct mode among these operations. As shown in FIG. 6, the transfer of the search image is completed before the motion vector search, by starting the transfer before the variable length decoding. Thus, it is possible to perform the motion vector search without waiting time.

It is to be noted here the transfer of the search image is not always completed by the time when the inverse frequency transform is completed. However, performing, in parallel, the search image transfer, variable length decoding, inverse quantization, and inverse frequency transform surely reduces the waiting time between the inverse frequency transform and the motion vector search, compared to the case of FIG. 3C.

The operations performed by the image decoding apparatus 200 have been described above.

In Embodiment 1, search image transfer time must be reduced in order to increase the performance, which increases the band width indicating the transfer amount per unit time. However, Embodiment 2 having the search image transfer unit 283 makes it possible to start transferring the search image in advance and perform the transfer during other processes, and thus it is possible to increase the transfer time compared to Embodiment 1. As a result, it is possible to reduce the band width required for the transfer from the frame memory 103.

It is to be noted that variable length coding in Embodiment 2 may be any other coding methods such as Huffman coding and run-length coding, arithmetic coding and the like.

The direct mode used in Embodiment 2 includes skip mode etc. that substantially uses the direct mode.

In Embodiment 2, the processing performed on processing targets other than direct-mode targets is the same as processing in the H.264 Standard, but other image coding standards such as the MPEG-2 Standard, the MPEG-4 Standard, the VC-1 Standard, and the like are possible. Alternatively, any other method is possible as long as the method supports plural direct modes and one of these is for calculating a motion vector by using pixel data of a reference image stored in a frame memory 103 as shown in NPL 3 cited in Embodiment 2.

Although the method of NPL 3 is used in Embodiment 2, any other method is possible as long as the method is for calculating a motion vector by using pixel data of a reference image stored in the frame memory 103. In addition, motion vector search ranges and accuracies are not limited to those in Embodiment 2, and may be determined freely. In the case where adjacent pixels are also required to calculate the sub-pixel accuracy positions when motion vector search is performed, the data of the required pixels may be stored in the search image memory 182.

Each of the processing units may be implemented as a circuit by exclusive hardware, or as a program on a processor.

The search image memory 182 and the reference image memory 192 are memories, but any other data storage elements such as flip-flops are possible. Alternatively, the search image memory 182 and the reference image memory 192 may be configured as parts of a memory area in a processor or as parts of a cache memory.

It is to be noted that the timing of starting search image transfer is immediately before variable length decoding in Embodiment 2, but any other timing before motion vector search is possible. Alternatively, the timing may be during the processing on the immediately-before macroblock.

Furthermore, when it is known that a current macroblock is not a direct mode, that is, an intra macroblock or a non-direct mode inter macroblock, the search image transfer may be completed or stopped at any timing. Stopping the transfer at an early timing reduces an wasteful transfer and thereby reduces the electric power consumption.

### Embodiment 3

Next, an image decoding apparatus according to Embodiment 3 of the present invention is schematically described. In Embodiments 1 and 2, search image transfer is performed for each macroblock to be decoded. The search area necessary to calculate a motion vector for a first macroblock is shifted to the right by only 16 pixels to determine the search area necessary for a second macroblock next to the first macroblock. Thus, most of the pixels can be re-used for the next search. Accordingly, only the pixels necessary for the next search is transferred from a frame memory to a search image memory.

In this way, it is possible to reduce the transfer amount and the band width required for the transfer. The outline of the image decoding apparatus in Embodiment 3 has been described above.

Next, the structure of the image decoding apparatus 200 in Embodiment 3 is described. The structure of the image decoding apparatus 200 in Embodiment 3 is the same as in FIG. 4 in Embodiment 2, and thus no description thereof is repeated.

It is to be noted that a search image memory 182 according to Embodiment 3 continuously stores at least a part of pixel data transferred from the frame memory 103 in the past. Next, a search image transfer unit 283 according to Embodiment 3 newly transfers only pixel data that has not yet been stored in the search image memory 182 among the pixel data in the search area for a current macroblock to be coded, from the frame memory 103 to the search image memory 182. Furthermore, the search image transfer unit 283 deletes, from the search image memory 182, the pixel data that is not used to calculate a motion vector for a following macroblock from among the pixel data transferred in the past.

The outline of the image decoding apparatus 200 in Embodiment 3 has been described above.

Next, operations performed by an image decoding apparatus 200 according to Embodiment 3 are schematically described. The whole operation flow is the same as in FIG. 5 in Embodiment 2, and thus no description thereof is repeated. In Embodiment 3, processing performed on processing targets other than direct-mode targets is the same as processing in the H.264 Standard as in Embodiment 1, and the operation method shown in NPL 3 is employed for the direct-mode targets.

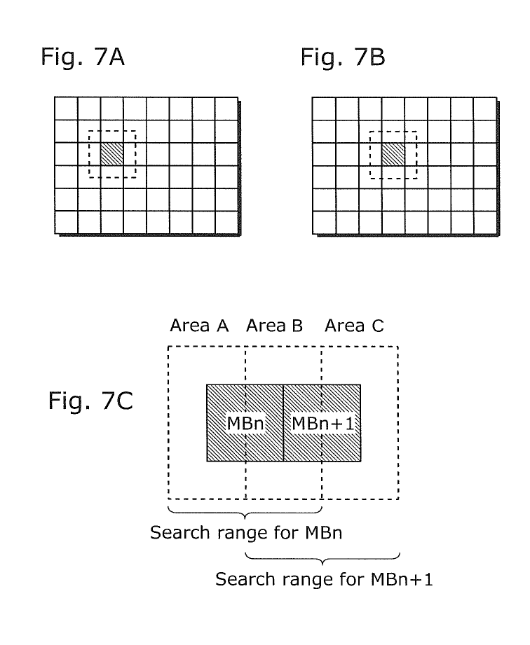

Embodiment 3 differs from Embodiment 2 in the range of search image transfer by the search image transfer unit 283. In Embodiment 2, the search image transfer unit 283 transfers all the search images required for motion vector search, from the frame memory 103 to the search image memory 182. Actually however, as shown in FIGS. 7A to 7C, most of the search images for macroblocks are overlapped with the search images for the immediately-before macroblocks.

FIG. 7A shows a search area in a macroblock MBn. When the search area corresponds to 32×32 pixels, the search area covers portions to the centers of the respective adjacent macroblocks. FIG. 7B shows a search area in a macroblock MBn+1 next to the macroblock MBn. FIG. 7C is a diagram of an enlarged view of search areas in the macroblock MBn and the macroblock MBn+1.

As shown in FIG. 7C, it is possible to divide the search area into three areas. Area A is an area required as the search area for only the macroblock MBn. Area B is an area required as the search areas for both the macroblock MBn and the macroblock MBn+1. Area C is an area required as the search area for only the macroblock MBn+1. In other words, it is clear that the motion vector calculation for the macroblock MBn+1 only requires that the data of Area A may be deleted, from among the data of Areas A and B of which data have already been transferred in the search image memory 182, and only the data of Area C is transferred from the frame memory 103 to the search image memory 182.

The operations performed by the image decoding apparatus 200 in Embodiment 3 have been described above.

In this way, it is possible to reduce both the transfer amount and the transfer band width by transferring only the data of the area newly required at the time when the previous search area is shifted in the horizontal direction from the frame memory 103 to the search image memory 182. Although data of 2048 Bytes needs to be transferred per macroblock in Embodiment 1, Embodiment 3 makes it possible to reduce the amount of data to 16×32×2=1024 Bytes per macroblock.

In addition, reducing the transfer amount makes it possible to reduce the amount of electric power required for the transfer at the same time.

It is to be noted that Embodiment 3 has been described with respect to Embodiment 2, but Embodiment 3 is also applicable to Embodiment 1 with a yield of the same advantageous effects.

The direct mode used in Embodiment 3 includes skip mode etc. that substantially uses the direct mode.

In Embodiment 3, the processing performed on processing targets other than direct-mode targets is the same as processing in the H.264 Standard, but other image coding standards such as the MPEG-2 Standard, the MPEG-4 Standard, the VC-1 Standard, and the like are possible. Alternatively, any other method is possible as long as the method supports plural direct modes and one of these is for calculating a motion vector by using pixel data of a reference image stored in a frame memory 103 as shown in NPL 3 cited in Embodiment 3.

Although the method of NPL 3 is used in Embodiment 3, any other method is possible as long as the method is for calculating a motion vector by using pixel data of a reference image stored in the frame memory 103. In addition, motion vector search ranges and accuracies are not limited to those in Embodiment 3, and may be determined freely. In the case where adjacent pixels are also required to calculate the sub-pixel accuracy positions when motion vector search is performed, the data of the required pixels may be stored in the search image memory 182.

In addition, although the 32×32 pixels that are composed of the decoded macroblock and parts of the respective adjacent macroblocks are searched in Embodiment 3, it is also possible to search the position shifted in the horizontal and vertical directions. The same advantageous effects can be obtained as long as the same amount of shift is made for each macroblock.

Each of the processing units may be implemented as a circuit by exclusive hardware, or as a program on a processor.

The search image memory 182 and the reference image memory 192 are memories, but any other data storage elements such as flip-flops are possible. Alternatively, the search image memory 182 and the reference image memory 192 may be configured as parts of a memory area in a processor or as parts of a cache memory.

### Embodiment 4

Next, an image decoding apparatus according to Embodiment 4 of the present invention is schematically described. In Embodiment 3, only the area not used as the search image for the macroblock decoded immediately before is transferred from among the search images required for motion vector search. However, storing, in a search image memory, the search image used for the macroblock located immediately above makes it possible to re-use a larger number of pixels for the next search because it is only necessary that the search image is shifted below by 16 pixels for the next search. Accordingly, transferring only the necessary pixels from the frame memory to the search image memory makes it possible to reduce the transfer amount and the transfer band width more significantly than in Embodiment 3.

The outline of the image decoding apparatus in Embodiment 4 has been described above.

Next, the structure of the image decoding apparatus 200 in Embodiment 4 is described. The structure of the image decoding apparatus 200 in Embodiment 4 is the same as in FIG. 4 in Embodiment 2, and thus no description thereof is repeated.

The outline of the image decoding apparatus 200 in Embodiment 4 has been described above.

Next, operations performed by an image decoding apparatus 200 according to Embodiment 4 are schematically described. The whole operation flow is the same as in FIG. 5 in Embodiment 2, and thus no description thereof is repeated. In Embodiment 4, as in Embodiment 1, processing performed on processing targets other than direct-mode targets is the same as processing in the H.264 Standard, and the operation method shown in NPL 3 is employed for the direct-mode targets.

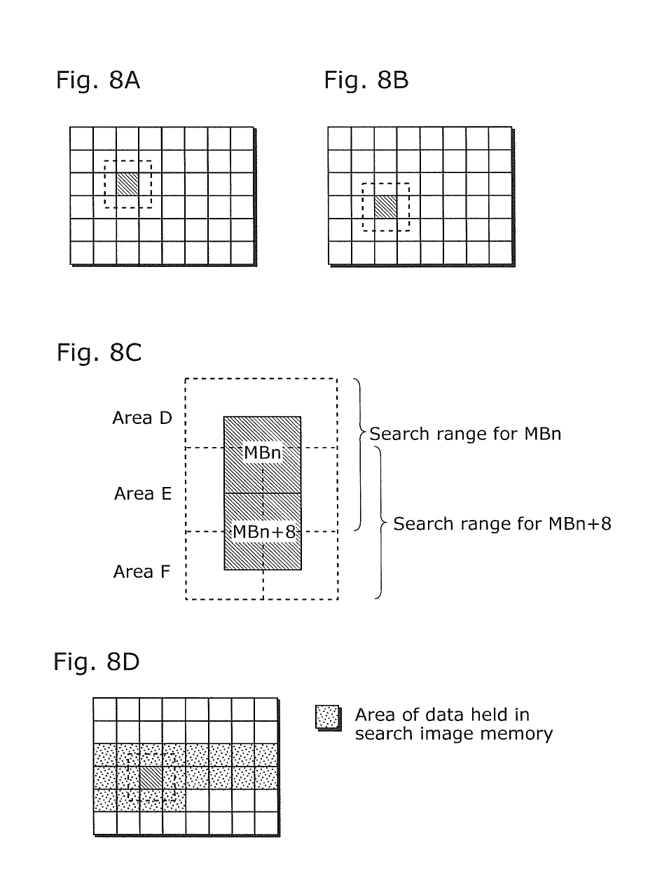

Embodiment 4 differs from Embodiment 3 in the range of search image transfer by the search image transfer unit 283. In Embodiment 3, the search image transfer unit 283 transfers only the difference from the search area for the macroblock decoded immediately before in the search area required for the motion vector search for the macroblock to be decoded, from the frame memory 103 to the search image memory 182. Actually however, as shown in FIGS. 8A to 8C, most of the search images for macroblocks are overlapped with the search images for the immediately-before macroblocks.

FIG. 8A shows a search area in a macroblock MBn. As shown in FIG. 8A, when the search area corresponds to 32×32 pixels, the search area covers portions to the centers of the respective adjacent macroblocks. FIG. 8B shows a search area in a macroblock MBn+8 next to the macroblock MBn. FIG. 8C is a diagram of an enlarged view of search areas in the macroblock MBn and the macroblock MBn+8.

As shown in FIG. 8C, it is possible to divide the search area into three areas. Area D is an area required as the search area for only the macroblock MBn. Area E is an area required as the search areas for both the macroblock MBn and the macroblock MBn+8. Area F is an area required as the search area for only the macroblock MBn+8. In other words, it is clear that the motion vector calculation for the macroblock MBn+8 only requires that the data of Area D may be deleted, from among the data of Areas D and E of which data have already been transferred in the search image memory 182, and only the data of Area F is transferred from the frame memory 103.

In addition, as described in Embodiment 3, the area corresponding to the left half of Area F in FIG. 8C has already been transferred from the frame memory 103 to the search image memory 182, in the motion vector search for the macroblock MBn+7 that is the macroblock immediately before the macroblock MBn+8. Thus, it is only necessary to newly add only the right half of Area F for the motion vector search for the macroblock MBn+8. Accordingly, it is clear that only the pixel data of this area needs to be transferred from the frame memory 103.

More specifically, in the case where the image decoding apparatus 200 sequentially decodes plural macroblocks making up a coded image from top left to bottom right of the coded image, it is only necessary for the search image transfer unit 283 to transfer the pixel data of the part corresponding to the bottom right corner of the search area (the right half of Area F) from the frame memory 103 to the search image memory 182 and delete, from the search image memory 182, the pixel data transferred before the part corresponding to the top left corner of the search area is transferred.

In Embodiment 4, the pixel data of the once-stored search area must be maintained until it is used for the immediately-below macroblock. Thus, the search image memory 182 needs to have a capacity in proportion to the horizontal size of the image to be decoded as shown in FIG. 8D.

In the example of FIG. 8D, the pixel data of a reference image is either transferred in units of a macroblock from the frame memory 103 or is deleted from the frame memory 103 in units of a macroblock. However, the present invention is not limited to the example. In other words, it is only necessary to transfer only the pixel data of the newly required area from the frame memory 103 or delete all the unnecessary pixel data from the image memory 182, without taking into account the macroblock boundaries.

The operations performed by the image decoding apparatus 200 in Embodiment 4 have been described above.

In this way, it is possible to reduce both the transfer amount and the transfer band width by transferring only the data of the area newly required at the time when the previous search area is shifted in the horizontal and vertical directions from the frame memory 103 to the search image memory 182. Although data of 2048 Bytes needs to be transferred per macroblock in Embodiment 1, Embodiment 4 makes it possible to reduce the amount of data to 16×16×2=1024 Bytes per macroblock.

In addition, reducing the transfer amount makes it possible to reduce the amount of electric power required for the transfer.

The direct mode used in Embodiment 4 includes skip mode etc. that substantially uses the direct mode.

In addition, in Embodiment 4, the processing performed on processing targets other than direct-mode targets is the same as processing in the H.264 Standard, but other image coding standards such as the MPEG-2 Standard, the MPEG-4 Standard, the VC-1 Standard, and the like are possible. Alternatively, any other method is possible as long as the method supports plural direct modes and one of these is for calculating a motion vector by using pixel data of a reference image stored in a frame memory 103 as shown in NPL 3 cited in Embodiment 4.

Although the method of NPL 3 is used in Embodiment 4, any other method is possible as long as the method is for calculating a motion vector by using pixel data of a reference image stored in the frame memory 103. In addition, motion vector search ranges and accuracies are not limited to those in Embodiment 4, and may be determined freely. In the case where adjacent pixels are also required to calculate the sub-pixel accuracy positions when motion vector search is performed, the data of the required pixels may be stored in the search image memory 182.

In addition, although 32×32 pixels that are composed of the decoded macroblock and parts of the respective adjacent macroblocks are searched in Embodiment 4, it is also possible to search the position shifted in the horizontal and vertical directions. The same advantageous effects can be obtained as long as the same amount of shift is made for each macroblock.

Each of the processing units may be implemented as a circuit by exclusive hardware, or as a program on a processor.

The search image memory 182 and the reference image memory 192 are memories, but any other data storage elements such as flip-flops are possible.

Alternatively, the search image memory 182 and the reference image memory 192 may be configured as parts of a memory area in a processor or as parts of a cache memory.

### Embodiment 5

Next, an image decoding apparatus according to Embodiment 5 of the present invention is schematically described. In Embodiments 1 to 4, the processes are sequentially performed. In Embodiment 5, the processes are performed in parallel on different macroblocks. This parallel processing makes it possible to increase the performance, maximize the time to transfer search images from a frame memory 103 to a search image memory 182, and minimize the transfer band width.

The outline of the image decoding apparatus in Embodiment 5 has been described above.

Next, the structure of the image decoding apparatus in Embodiment 5 is described. The structure of the image decoding apparatus in Embodiment 5 is the same as in FIG. 4 in Embodiment 2, and thus no description thereof is repeated.

The outline of the image decoding apparatus in Embodiment 5 has been described above.

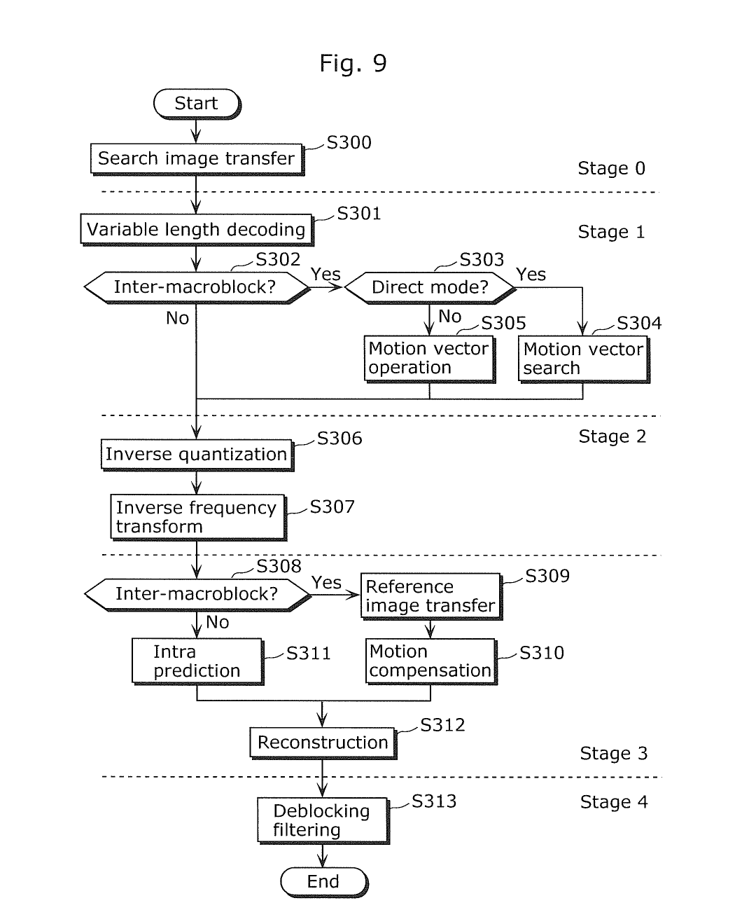

Next, the operations performed by the image decoding apparatus 200 shown in FIG. 4 are described with reference to the flowchart in FIG. 9. FIG. 9 shows decoding processes on a single macroblock. In Embodiment 5, since the respective processing blocks are performed on different macroblocks, the processing flow is partly different from that in Embodiment 2. In addition, dotted lines in the horizontal direction in the flowchart show the boundaries between the groups of the processes. In Embodiment 5, as in Embodiment 1, processing performed on processing targets other than direct-mode targets is the same as processing in the H.264 Standard, and the operation method shown in NPL 3 is employed for the direct-mode targets.

First, in a search image transfer unit 283, search images for use in motion vector search in the direct mode are transferred from the frame memory 103 to the search image memory 182 (S300). As shown in FIG. 32, in the case where the search area corresponds to 32×32 pixels, the position of the search area of each of two reference images is the 32×32 pixels that are composed of the decoded macroblock and parts of the respective adjacent pixels. When the top left position of the decoded macroblock is represented as (x, y) in two-dimensional coordinates, the search area is the area of 32×32 pixels having the top left pixel at the position of (x−8, y−8).

The search image transfer can be started because the motion vector search in NPL 3 searches, on top of the processes, a search area of 32×32 pixels that has, as a center, the spatial position co-located with a current macroblock to be decoded as shown in FIG. 32 in Embodiment 2. In this way, the search area is uniquely determined before the variable length decoding unit 104 performs variable length decoding to decode coding information and coefficient information included in a coded stream. This makes it possible to transfer the pixel data in the search area.

Next, the variable length decoding unit 104 performs variable length decoding on an input coded stream (S301). The variable length decoding unit 104 outputs coding information and coefficient information. The coding information includes macroblock types, intra-picture prediction (intra prediction) mode, motion vector information, and quantization parameters, and the coefficient information corresponds to each pixel data. The coding information is output to the control unit 101, and then input to each processing unit.

Next, whether a current macroblock to be decoded is an inter macroblock or an intra macroblock is determined (S302). When the current macroblock is an inter macroblock (Yes in S302), whether the inter macroblock is a direct mode or not is determined (S303). In the case of the direct mode (Yes in S303), the motion vector operating unit 181 performs motion vector search using a search image in the search image memory 182 to calculate the motion vector (S304).

As shown in FIG. 32, in the case of two reference pictures L0 and L1 stored in the search image memory 182, first, the pixels in the top left position in the search area in the reference picture L0 and the pixels in the bottom right position in the search area in the reference picture L1 are compared with each other to calculate the SADs. Next, SADs are sequentially calculated by shifting to the right in the reference picture L0, and shifting to the left in the reference picture L1. In this way, SADs are sequentially calculated, and the position that yields the smallest SAD is regarded as the most similar position. The vector is converted into motion vectors mvL0 and mwL1 starting from the decoded macroblock of the decoded picture.

When the current macroblock is not a direct mode (No in S303), the motion vector operating unit 181 performs motion vector operation to calculate a motion vector (S305). The H.264 Standard defines, when adjacent motion vectors are mvA, mvB, and mvC, the median value of these vectors is the prediction motion vector. A motion vector is calculated by adding this prediction motion vector and motion vector information (the difference value of the motion vector) included in the coded stream.

Here, the determination as to whether a current macroblock to be decoded is an inter macroblock (S302) or determination as to whether the current macroblock to be decoded is a direct mode (S303) are made after variable length decoding process (S301) by a variable length decoding unit 104 is completed. However, these determinations may be made at the time when coding information required to make these determinations is decoded.

Next, the coefficient information output by the variable length decoding unit 104 is subjected to inverse quantization by an inverse quantization unit 105 (S306) and then to inverse frequency transform by an inverse frequency transform unit 106 (S307).

Next, whether a current macroblock to be decoded is an inter macroblock or an intra macroblock is determined (S308). In the case of an inter macroblock (Yes in S308), a motion compensation unit 109 transfers the search image from the frame memory 103 to a reference image memory 192, using the motion vector output by the motion vector calculating unit 208 (S309). Next, the motion compensation unit 109 performs motion compensation using the pixel data in the reference area stored in the reference image memory 192 to generate a prediction image (S310). On the other hand, in the case of a non-inter macroblock (No in S308), the intra prediction unit 107 performs intra prediction to generate a prediction image (S311).

The reconstructing unit 111 adds the resulting prediction image and the difference image output by the inverse frequency transform unit 106 to generate a decoded image (S312). Next, the deblocking filter unit 112 performs deblocking filtering for reducing blocking noise on the decoded image, and stores the outcome in the frame memory 103 (S313).

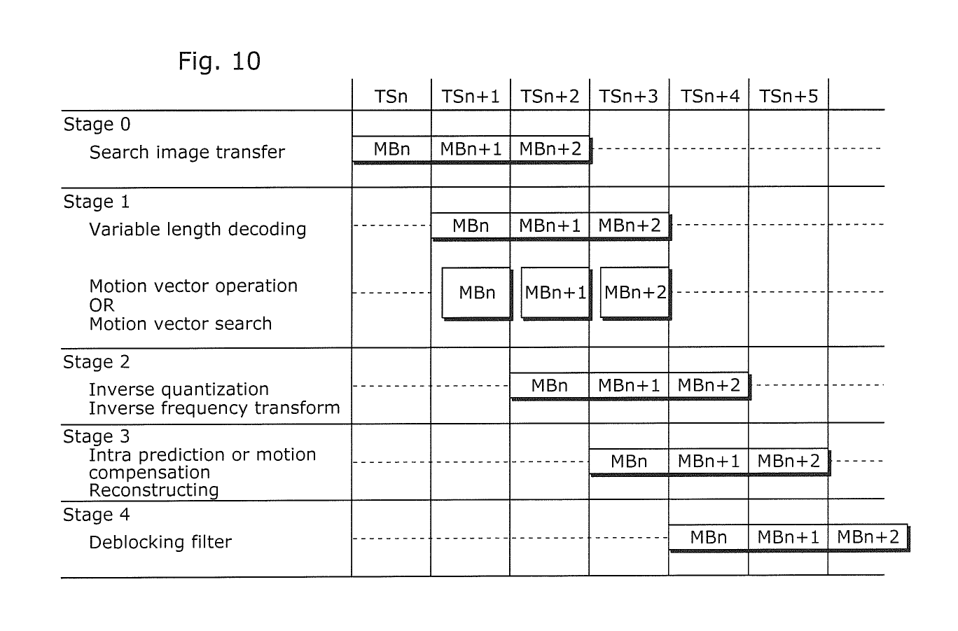

Here, it is assumed in FIG. 9 that search image transfer (S300) is Stage 0, processes starting with variable length decoding (S301) and ending with the stage immediately before inverse quantization (S306) is Stage 1, inverse quantization (S306) and inverse frequency transform (S307) is Stage 2, intra prediction (S311), reference image transfer (S309), motion compensation (S310), and reconstruction (S312) are Stage 3, and deblocking filtering (S313) is Stage 4. A control unit 101 controls the operation timings of the respective processing units so that the respective stages from Stage 0 to Stage 4 are performed on the different macroblocks. These operations are described with reference to FIG. 10.

In FIG. 10, TSs (Time Slots) represent time intervals, and units of time indicating the processing time required to decode a single macroblock. Although these equal intervals are arranged in FIG. 10, but intervals may not always need to be equal. In FIG. 10, macroblocks before the macroblock MBn−1 and after the macroblock MBn+3 are not shown.

In TSn, at Stage 0, the macroblock MBn is processed. In TSn+1, the macroblock MBn+1 is processed at Stage 0, and the macroblock MBn is processed at Stage 1. In other words, the search image transfer unit 283 transfers the pixel data in the search area for the (n+1)th macroblock from the frame memory 103 to the search image memory 182, in parallel with motion vector operation or search performed on the nth (n: natural number) macroblock in decoding order from among the macroblocks making up the coded image.

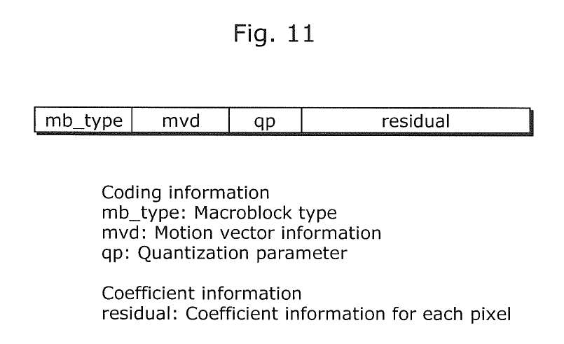

Here, FIG. 11 shows a general coding stream. At Stage 1, the motion vector operating unit 181 performs motion vector calculation (S305) or motion vector search (S304) after the variable length decoding unit 104 completes decoding of at least macroblock type and motion vector information among the coding information in FIG. 11.

In other words, only when a current macroblock to be decoded is determined to be a macroblock coded in the direct mode, based on the macroblock type and motion vector information stored at the heading portion of the coded stream, the motion vector operation or motion vector search is started. In this way, there is no need to execute unnecessary processing, and thus power consumption is small.

In TSn+2, the macroblock MBn+2 is processed at Stage 0, the macroblock MBn+1 is processed at Stage 1, and the macroblock MBn is processed at Stage 2. These processing blocks perform these processes in parallel, which makes it possible to increase the operation speed as a whole. In the case of dividing the whole processing into five stages, the whole operation speed is five times faster than in the case of not dividing the whole processing into stages.

The operations performed by the image decoding apparatus 200 in Embodiment 5 have been described above.

In Embodiment 5, the time-series processing is divided into the aforementioned stages, and search image transfer is performed at Stage 0. Thus, it is possible to perform the search image transfer during the whole processing time without spending any wasteful time. For this reason, compared to FIG. 6 in Embodiment 2, Embodiment 5 eliminates idle time, thereby making it possible to use more time for search image transfer. As a result, it is possible to reduce the transfer band width.

It is to be noted that Embodiment 5 has been described with respect to Embodiment 4, but Embodiment 5 is also applicable to Embodiments 2 and 3 with a yield of the same advantageous effect of reducing the transfer band width.

It is to be noted that variable length coding in Embodiment 5 may be any other coding methods such as Huffman coding and run-length coding, arithmetic coding, and the like.

The direct mode used in Embodiment 5 includes skip mode etc. that substantially uses the direct mode.

In addition, in Embodiment 5, the processing performed on processing targets other than direct-mode targets is the same as processing in the H.264 Standard, but other image coding standards such as the MPEG-2 Standard, the MPEG-4 Standard, the VC-1 Standard, and the like are possible. Alternatively, any other method is possible as long as the method supports plural direct modes and one of these is for calculating a motion vector by using pixel data of a reference image stored in a frame memory 103 as shown in NPL 3 cited in Embodiment 5.

Although the method of NPL 3 is used in Embodiment 5, any other method is possible as long as the method is for calculating a motion vector by using pixel data of a reference image stored in the frame memory 103. In addition, motion vector search ranges and accuracies are not limited to those in Embodiment 5, and may be determined freely. In the case where adjacent pixels are also required to calculate the sub-pixel accuracy positions when motion vector search is performed, the data of the required pixels may be stored in the search image memory 182.

Each of the processing units may be implemented as a circuit by exclusive hardware, or as a program on a processor.

The search image memory 182 and the reference image memory 192 are memories, but any other data storage elements such as flip-flops are possible. Alternatively, the search image memory 182 and the reference image memory 192 may be configured as parts of a memory area in a processor or as parts of a cache memory.

In addition, the scheme of dividing the processing into stages in Embodiment 5 is one example, and thus division schemes are not limited to the above-described division scheme. It is possible to freely select one of the division schemes according to the processing characteristics.

### Embodiment 6

Next, an image decoding apparatus according to Embodiment 6 of the present invention is schematically described. Embodiment 5 has described that it is possible to reduce the transfer band width by performing parallel transfer of search images. Embodiment 6 further describes that it is possible to perform motion vector search more efficiently by eliminating wasteful time, more specifically, by starting speculative motion vector search in advance.

The outline of the image decoding apparatus in Embodiment 6 has been described above.

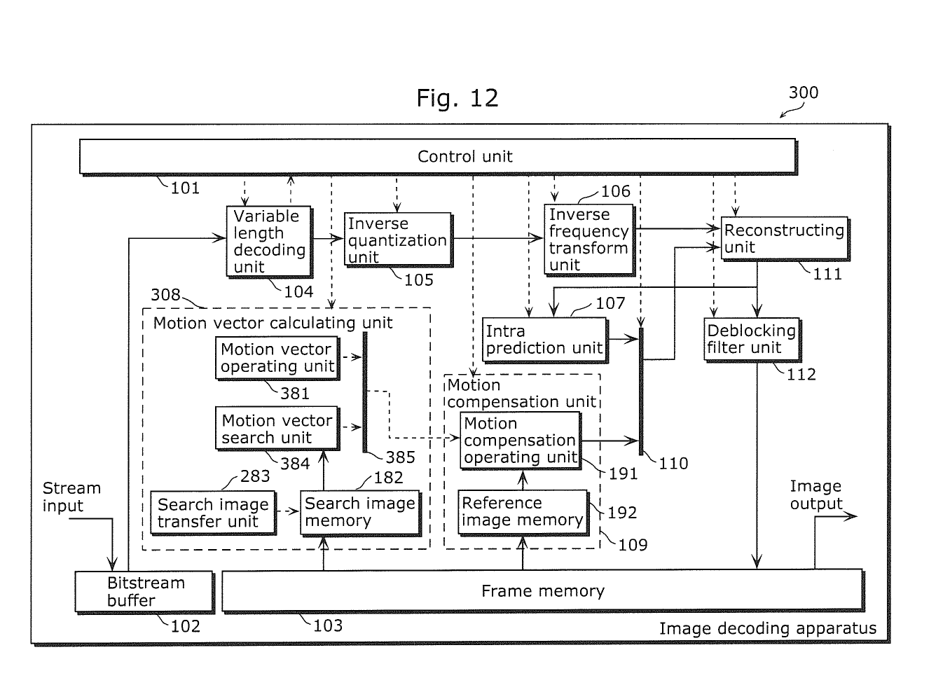

Next, the structure of the image decoding apparatus 300 in Embodiment 6 is described. FIG. 12 is a diagram showing a structure of the image decoding apparatus 300 in Embodiment 6. The image decoding apparatus 300 in Embodiment 6 includes: a motion vector search unit 384 (corresponding to the motion vector operating unit 50 in FIG. 1B) which performs motion vector search using a reference image in the case of a direct mode; a motion vector operating unit 381 which calculates a motion vector in the case of the direct mode; and a switch 385 which switches a motion vector output by the motion vector operating unit 381 and a motion vector output by the motion vector search unit 384. The other structural elements are the same as in FIG. 4 in Embodiment 2. Thus, the same reference signs are assigned thereto and the same descriptions thereof are not repeated.

The outline of the image decoding apparatus 300 in Embodiment 6 has been described above.

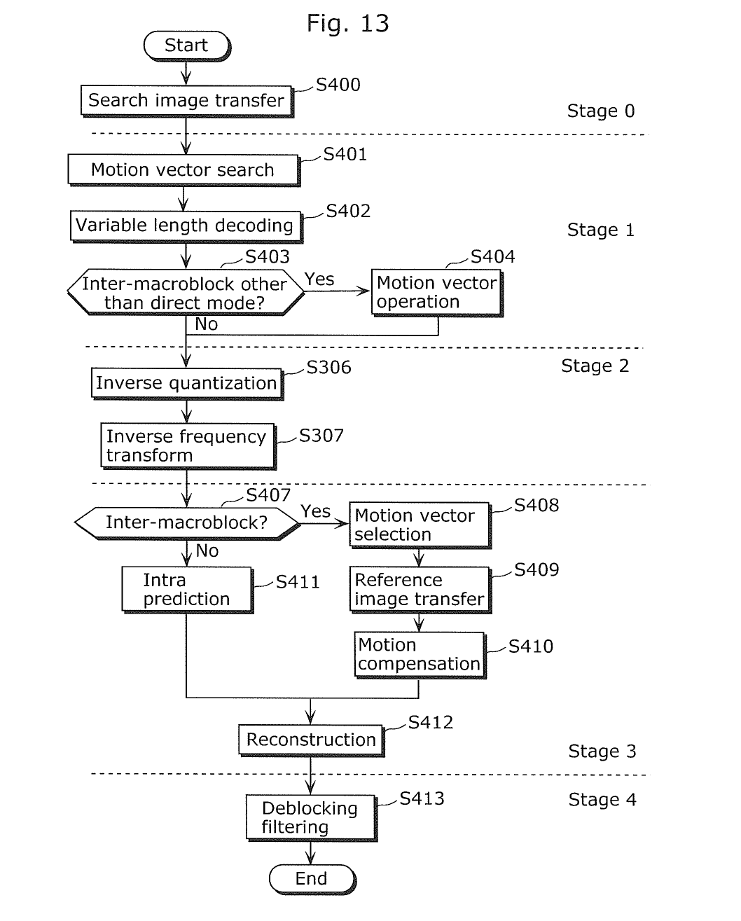

Next, the operations performed by the image decoding apparatus 300 shown in FIG. 12 are described with reference to the flowchart in FIG. 13.

FIG. 13 shows decoding processes on a single macroblock. In Embodiment 6, since the motion vector search unit 384 is newly added, the processing flow is partly different from that in Embodiment 5. In addition, the dotted lines in the horizontal direction in the flowchart show the boundaries between the processing stages as in FIG. 9. Detailed descriptions are provided later. Also in Embodiment 6, as in the earlier-described Embodiments 1 to 5, processing performed on processing targets other than direct-mode targets is the same as processing in the H.264 Standard, and the operation method shown in NPL 3 is employed for the direct-mode targets.

First, in a search image transfer unit 283, search images for use in motion vector search in the direct mode are transferred from the frame memory 103 to the search image memory 182 (S400). As shown in FIG. 32, in the case where the search area corresponds to 32×32 pixels, the position of the search area of each of two reference images is the 32×32 pixels that are composed of the decoded macroblock and parts of the respective adjacent pixels. When the top left position of the macroblock to be decoded is represented as (x, y) in two-dimensional coordinates, the search area is the area of 32×32 pixels having the top left pixel at the position of (x−8, y−8).

The search image transfer can be started because the motion vector search in NPL 3 searches, on top of the processes, a search area of 32×32 pixels that has, as a center, the spatial position co-located with a current macroblock to be decoded as shown in FIG. 32 in Embodiment 2. In this way, the search area is uniquely determined before the variable length decoding unit 104 performs variable length decoding on coding information and coefficient information included in a coded stream. This makes it possible to transfer the pixel data in the search area.

Next, the motion vector search unit 384 performs motion vector search (S401). The motion vector search can be performed on top of the other processes for the earlier mentioned reasons as to why the transfer can be performed by the search image transfer unit 283. In other words, the motion vector search can be performed as long as the pixel data of the search area is stored in the search image memory 182.

Next, the variable length decoding unit 104 performs variable length decoding on an input coded stream (S402). The variable length decoding unit 104 outputs coding information and coefficient information. The coding information includes macroblock types, intra-picture prediction (intra prediction) mode, motion vector information, and quantization parameters, and the coefficient information corresponds to each pixel data. The coding information is output to the control unit 101, and then input to each processing unit.

Next, a determination is made as to whether the current macroblock is a non-direct mode inter macroblock or not (S403). In the case of the non-direct mode inter macroblock (Yes in S403), the motion vector operating unit 381 performs motion vector operation to calculate a motion vector (S404). The H.264 Standard defines, when adjacent motion vectors are mvA, mvB, and mvC, the median value of these vectors is the prediction motion vector. A motion vector is calculated by adding this prediction motion vector and motion vector information (the difference value of the motion vector) included in the coded stream.

Next, the coefficient information output by the variable length decoding unit 104 is subjected to inverse quantization by an inverse quantization unit 105 (S405), and then inverse frequency transform by an inverse frequency transform unit 106 (S406).

Next, whether a current macroblock to be decoded is an inter macroblock or an intra macroblock is determined (S407). In the case of an inter macroblock (Yes in S407), the motion compensation unit 109 transfers the pixel data in the reference area using the motion vector selected by the switch 385, from the frame memory 103 to the reference image memory 192 (S409).

The switch 385 in the motion vector calculating unit 308 selects and outputs the motion vector output by the motion vector search unit 384 in the case of the direct mode, and otherwise selects and outputs the motion vector output by the motion vector operating unit 381 (S408).

Next, the motion compensation unit 109 performs motion compensation using the pixel data of the reference area stored in the reference image memory 192 to generate a prediction image (S410). On the other hand, in the case of a non-inter macroblock (No in S407), the intra prediction unit 107 performs intra prediction to generate a prediction image (S411).

The reconstructing unit 111 adds the resulting prediction image and the difference image output by the inverse frequency transform unit 106 to generate a decoded image (S412). Next, the deblocking filter unit 112 performs deblocking filtering for reducing blocking noise on the decoded image, and stores the outcome in the frame memory 103 (S413).

Here, it is assumed in FIG. 13 that search image transfer (S400) is Stage 0, processes starting with motion vector search (S401) and ending with the stage immediately before inverse quantization (S405) is Stage 1, inverse quantization (S405) and inverse frequency transform (S406) is Stage 2, intra prediction (S411), reference image transfer (S409), motion compensation (S410), and reconstruction (S411) are Stage 3, and deblocking filtering (S412) is Stage 4.

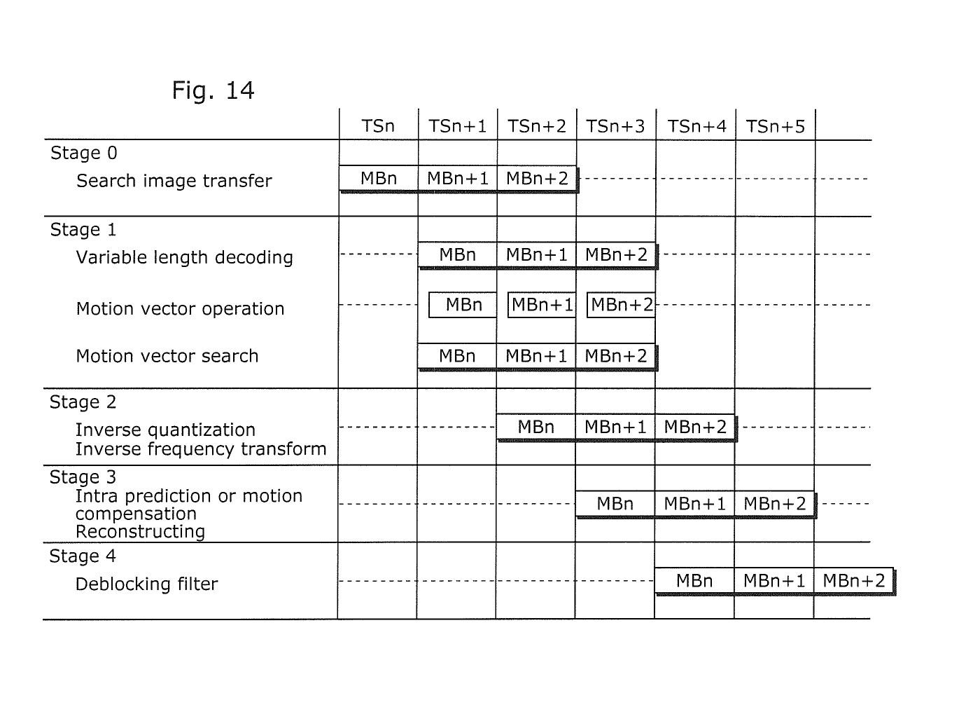

A control unit 101 controls the operation timings of the respective processing units so that the respective stages from Stage 0 to Stage 4 are performed on the different macroblocks. These operations are described with reference to FIG. 14. In FIG. 14, a TS (Time Slot) represents a time interval, and a unit of time indicating the processing time required to decode a single macroblock. Although these equal intervals are arranged in FIG. 14, but intervals may not always need to be equal. In FIG. 14, macroblocks before the macroblock MBn−1 and after the macroblock MBn+3 are not shown.

In TSn, At Stage 0, the macroblock MBn is processed. In TSn+1, the macroblock MBn+1 is processed at Stage 0, and the macroblock MBn is processed at Stage 1. Here, in Stage 1 in FIG. 9, the motion vector search process (S304) by the motion vector operating unit 181 starts in the middle of the variable length decoding (S301) by the variable length decoding unit 104, that is, after the macroblock type and motion vector information are decoded. Stage 1 in FIG. 14 differs from Stage 1 in FIG. 9 in that the process of the motion vector search (S401) by the motion vector search unit 384 is performed on the macroblock MBn immediately after the start of TSn+1. In other words, the process of the motion vector operation or motion vector search is started without making any determination as to whether the current macroblock to be decoded is a direct mode or not.

In TSn+2, the macroblock MBn+2 is processed at Stage 0, the macroblock MBn+1 is processed at Stage 1, and the macroblock MBn is processed at Stage 2. These processing blocks operates in parallel in this parallel processing, which makes it possible to increase the operation speed as a whole. In the case of dividing the whole processing into five stages, the whole operation speed is five times faster than in the case of not dividing the decoding processing into stages.

The operations performed by the image decoding apparatus 300 in Embodiment 6 have been described above.

According to Embodiment 6, the motion vector search unit 384 is caused to operate before the variable length decoding unit 104 decodes the macroblock type etc. Next, the switch 385 switches the motion vector output by the motion vector search unit 384 and the motion vector output by the motion vector operating unit 381 to eliminate the idle time in which the motion vector search unit 384 cannot operate and thereby enables efficient operation.

It is to be noted that variable length coding in Embodiment 6 may be any other coding methods such as Huffman coding and run-length coding, arithmetic coding and the like.

The direct mode used in Embodiment 6 includes skip mode etc. that substantially uses the direct mode.

In addition, in Embodiment 6, the processing performed on processing targets other than direct-mode targets is the same as processing in the H.264 Standard, but other image coding standards such as the MPEG-2 Standard, the MPEG-4 Standard, the VC-1 Standard, and the like are possible. Alternatively, any other method is possible as long as the method supports plural direct modes and one of these is for calculating a motion vector by using pixel data of a reference image stored in a frame memory 103 as shown in NPL 3 cited in Embodiment 6.

Although the method of NPL 3 is used in Embodiment 6, any other method is possible as long as the method is for calculating a motion vector by using pixel data of a reference image stored in the frame memory 103. In addition, motion vector search ranges and accuracies are not limited to those in Embodiment 6, and may be determined freely. In the case where adjacent pixels are also required to calculate the sub-pixel accuracy positions when motion vector search is performed, the data of the required pixels may be stored in the search image memory 182.

Each of the processing units may be implemented as a circuit by exclusive hardware, or as a program on a processor.

The search image memory 182 and the reference image memory 192 are memories, but any other data storage elements such as flip-flops are possible. Alternatively, the search image memory 182 and the reference image memory 192 may be configured as parts of a memory area in a processor or as parts of a cache memory.

In addition, the scheme of dividing the processing into stages in Embodiment 6 is one example, and thus division schemes are not limited to the above-described division scheme. It is possible to freely select one of the division schemes according to the processing characteristics.

In addition, in Embodiment 6, the motion vector search unit 384 always keeps operating until a motion vector is calculated. However, actually, it is possible to perform control such that the operation is stopped at the time when the motion vector to be output by the motion vector search unit 384 is found not to be used.

### Embodiment 7

Next, an image decoding apparatus according to Embodiment 7 of the present invention is schematically described. In Embodiments 1 to 6, a search image memory for use in motion vector search and a reference image memory for use in motion compensation are not connected to each other. In other words, a motion compensation unit always transfers the pixel data in a reference area from the frame memory to the reference image memory, and performs a motion compensation process.

In Embodiment 7, in the case of a direct mode, the reference image is obtained from the search image memory, taking advantage that the reference image to be used in the motion compensation process is already stored in the search image memory. In this way, it is possible to reduce wasteful transfer and the transfer amount.

The outline of the image decoding apparatus in Embodiment 7 has been described above.

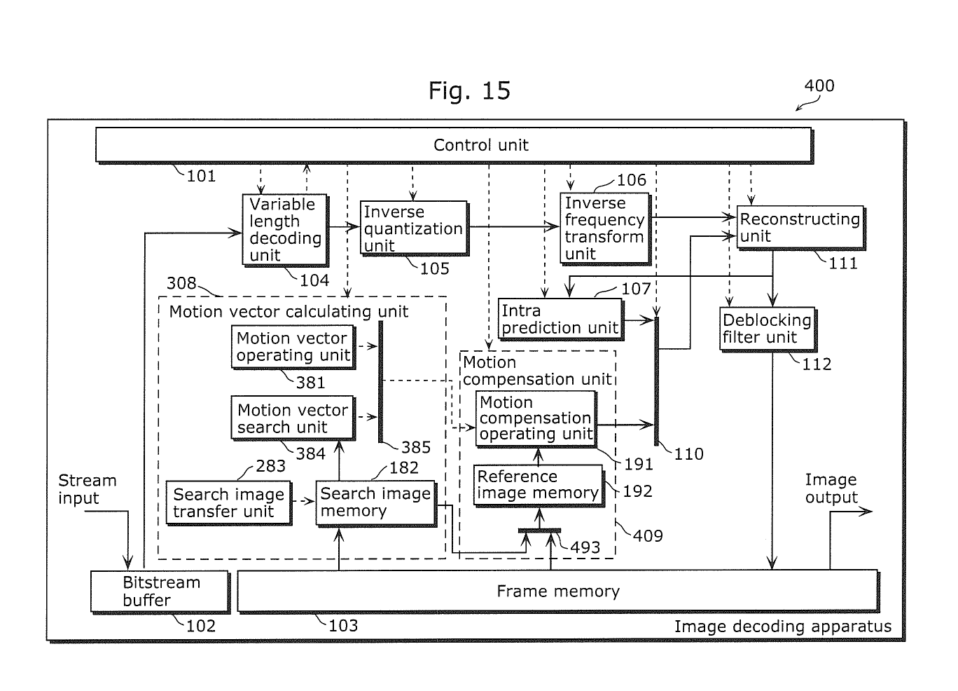

Next, the structure of the image decoding apparatus 100 in Embodiment 7 is described. FIG. 15 is a diagram showing a structure of the image decoding apparatus 400 in Embodiment 7. The image decoding apparatus 400 in Embodiment 7 includes a switch (reference area transfer unit) 493 which switches between transferring the pixel data in the reference image from the frame memory 103 to the reference image memory (the third memory unit) 192 and transferring the pixel data in the reference area from the search image memory 182 to the reference image memory 192. The other structural elements are the same as in FIG. 12 in Embodiment 6. Thus, the same reference signs are assigned thereto and the same descriptions thereof are not repeated.

The outline of the image decoding apparatus 400 in Embodiment 7 has been described above.

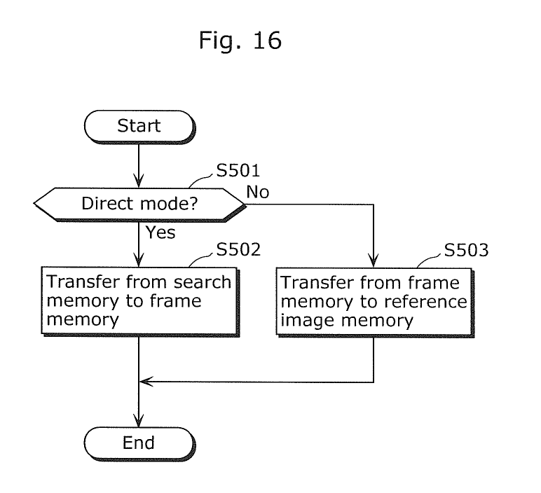

The image decoding apparatus 400 shown in FIG. 15 performs basically the same processes as in FIG. 13 that shows a flowchart of processes performed in Embodiment 6, but performs a reference image transfer operation different from that in FIG. 13. Thus, this difference is detailed next with reference to FIG. 16. Also in Embodiment 7, as in the earlier described embodiments, processing performed on processing targets other than direct-mode targets is the same as processing in the H.264 Standard, and the operation method shown in NPL 3 is employed for the direct-mode targets.

As shown in FIG. 16, whether a current macroblock to be decoded is a direct mode or not is determined first at the time when the motion compensation unit 409 performs reference image transfer (S501). In the case of a direct mode (Yes in S501), the pixel data of the reference area to be used is always stored in the search image memory 182. For this reason, the pixel data in the reference area is transferred from the search image memory 182 to the reference image memory 192 by switching of the switch 493 (S502).

On the other hand, in the case of a non-direct mode (No in S501), the pixel data in the reference area is transferred from the frame memory 103 to the reference image memory 192, as in the earlier described Embodiments 1 to 7.

The other processes are the same as in Embodiment 5, and thus the same descriptions are not repeated.

With this configuration, a reference image to be used by the motion compensation unit 409 is already present in the search image memory 182 when the direct mode is selected, and thus there is no need to transfer the reference image from the frame memory 103 to the reference image memory 192. For this reason, it is possible to reduce the amount of transfer from an external memory.

In addition, reducing the transfer amount makes it possible to reduce the amount of electric power required for the transfer.

The direct mode used in Embodiment 7 includes skip mode etc. that substantially uses the direct mode.

In addition, in Embodiment 7, the processing performed on processing targets other than direct-mode targets is the same as processing in the H.264 Standard, but other image coding standards such as the MPEG-2 Standard, the MPEG-4 Standard, the VC-1 Standard, and the like are possible. Alternatively, any other method is possible as long as the method supports plural direct modes and one of these is for calculating a motion vector by using pixel data of a reference image stored in a frame memory 103 as shown in NPL 3 cited in Embodiment 7.

Although the method of NPL 3 is used in Embodiment 7, any other method is possible as long as the method is for calculating a motion vector by using pixel data of a reference image stored in the frame memory 103. In addition, motion vector search ranges and accuracies are not limited to those in Embodiment 7, and may be determined freely. In the case where adjacent pixels are required to calculate the sub-pixel accuracy positions when motion vector search is performed, the data of the required pixels may be stored in the search image memory 182.

Each of the processing units may be implemented as a circuit by exclusive hardware, or as a program on a processor.

The search image memory 182 and the reference image memory 192 are memories, but any other data storage elements such as flip-flops are possible. Alternatively, the search image memory 182 and the reference image memory 192 may be configured as parts of a memory area in a processor or as parts of a cache memory.

In Embodiment 7, a reference image is transferred from the search image memory 182 to the reference image memory 192. However, it is also good that the motion compensation operating unit 191 directly accesses the search image memory 182, reads out the reference image, and perform motion compensation operation using the read out reference image.

### Embodiment 8

Next, an image decoding apparatus according to Embodiment 8 of the present invention is schematically described. In Embodiment 7, a reference image is transferred from the search image memory to the reference image memory and then motion compensation process is performed only in the case of a direct mode. In Embodiment 8, a determination is made as to whether a reference image indicated by a motion vector is present in the search image memory or not even in the case of a non-direct mode. When the reference image is present in the search image memory, the reference image is obtained from the search image memory. In this way, it is possible to reduce wasteful transfer and the transfer amount.

The outline of the image decoding apparatus in Embodiment 8 has been described above.

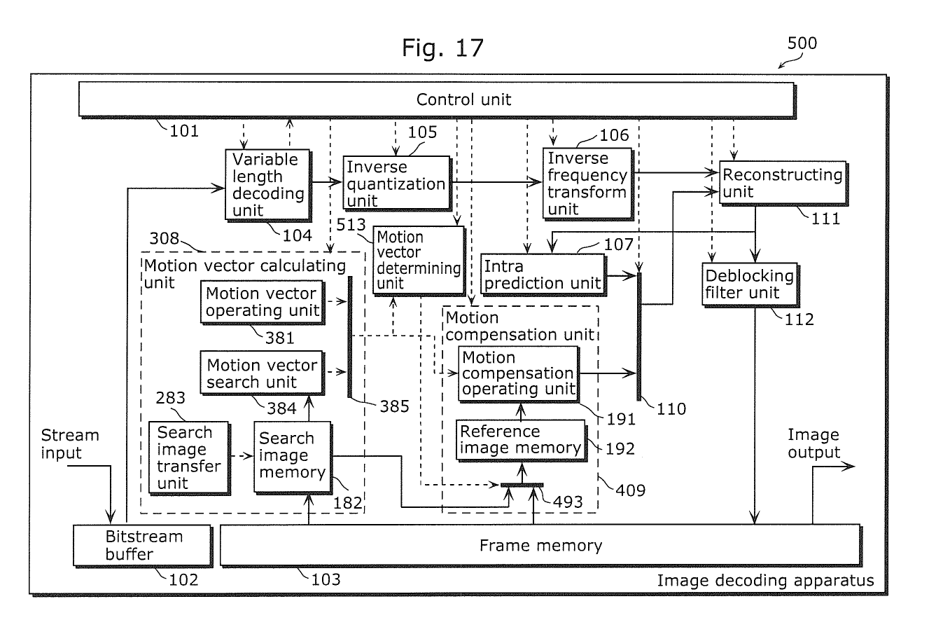

Next, the structure of the image decoding apparatus 500 in Embodiment 8 is described. FIG. 17 is a diagram showing a structure of the image decoding apparatus 500 in Embodiment 8. The image decoding apparatus 500 in Embodiment 8 includes a motion vector determining unit 513 which determines whether the reference image indicated by the motion vector is present in the search image memory 182 or not. The other structural elements are the same as in FIG. 15 in Embodiment 7. Thus, the same reference signs are assigned thereto and the same descriptions thereof are not repeated.

The outline of the image decoding apparatus 500 in Embodiment 8 has been described above.

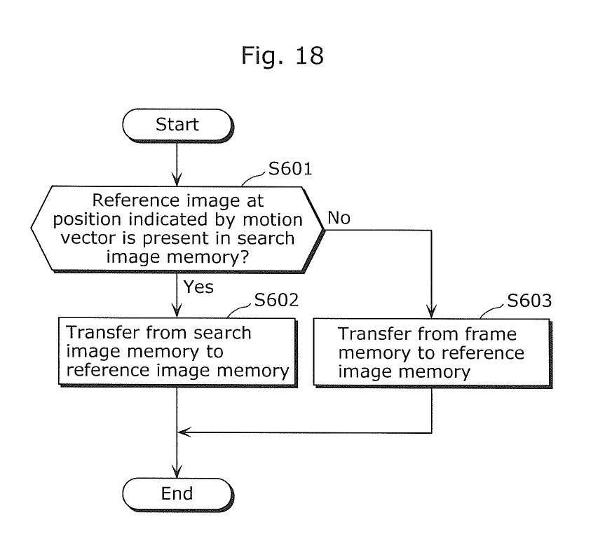

The image decoding apparatus 500 shown in FIG. 17 performs basically the same processes as in FIG. 13 that shows a flowchart of processes performed in Embodiment 6. However, it performs a reference image transfer (S409) different from that in FIG. 13. Thus, detailed descriptions are given next with reference to FIG. 18. In Embodiment 8, as in the earlier described Embodiments 1 to 7, processing performed on processing targets other than direct-mode targets is the same as processing in the H.264 Standard, and the operation method shown in NPL 3 is employed for the direct-mode targets.

As shown in FIG. 18, the motion vector determining unit 513 determines whether the reference image indicated by the motion vector calculated by the motion vector calculating unit 308 is present in the search image memory 182 or not, when the motion compensation unit 409 transfers the reference image (S601). When the reference image is present in the search image memory 182 (Yes in S601), the reference image is transferred from the search image memory 182 to the reference image memory 192 by the switch 493 (S602). The motion vector determining unit 513 always determines that the reference image is present in the search image memory 182 in the case of the direct mode.

On the other hand, when the motion vector determining unit 513 determines that the reference image is not present in the search image memory 182 (No in S601), the reference image is transferred from the frame memory 103 to the reference image memory 192.

The other processes are the same as in Embodiment 7, and thus the same descriptions are not repeated.

The operations performed by the image decoding apparatus 500 in Embodiment 8 have been described above.

With this configuration, in the case where a reference image to be used by the motion compensation unit 409 is already present in the search image memory 182 irrespective of whether the direct mode is selected or not, there is no need to transfer the reference image from the frame memory 103 to the reference image memory 192. For this reason, it is possible to reduce the amount of transfer from an external memory.

In addition, reducing the transfer amount makes it possible to reduce the amount of electric power required for the transfer.

The direct mode used in Embodiment 8 includes skip mode etc. that substantially uses the direct mode.

In addition, in Embodiment 8, the processing performed on processing targets other than direct-mode targets is the same as processing in the H.264 Standard, but other image coding standards such as the MPEG-2 Standard, the MPEG-4 Standard, the VC-1 Standard, and the like are possible. Alternatively, any other method is possible as long as the method supports plural direct modes and one of these is for calculating a motion vector by using pixel data of a reference image stored in a frame memory 103 as shown in NPL 3 cited in Embodiment 8.

Although the method of NPL 3 is used in Embodiment 8, any other method is possible as long as the method is for calculating a motion vector by using pixel data of a reference image stored in the frame memory 103. In addition, motion vector search ranges and accuracies are not limited to those in Embodiment 8, and may be determined freely. In the case where adjacent pixels are required to calculate the sub-pixel accuracy positions when motion vector search is performed, the data of the required pixels may be stored in the search image memory 182.

Each of the processing units may be implemented as a circuit by exclusive hardware, or as a program on a processor.

The search image memory 182 and the reference image memory 192 are memories, but any other data storage elements such as flip-flops are possible. Alternatively, the search image memory 182 and the reference image memory 192 may be configured as parts of a memory area in a processor or as parts of a cache memory.

In Embodiment 8, a reference image is transferred from the search image memory 182 to the reference image memory 192. However, it is also good that the motion compensation operating unit 191 directly accesses the search image memory 182, reads out the reference image, and performs motion compensation operation using the read out reference image.

### Embodiment 9

Next, an image decoding apparatus according to Embodiment of the present invention is schematically described. In Embodiment 8, it may be difficult to achieve a search image memory because of a concentration of access to the search image memory. Examples of such access include writing from the frame memory, reading from the reference image memory, and reading by the motion vector search unit.

For this reason, in Embodiment 9, an area that is not used in a current search among the pixel data read out from the frame memory is disposed in a shared memory prepared additionally to leave, in the search image memory, only the pixel data of the search area required to decode the current macroblock. In this way, it is possible to reduce the number of times of access to the search image memory, and simplify the configuration of the search image memory.

The outline of the image decoding apparatus 600 in Embodiment 9 has been described above.

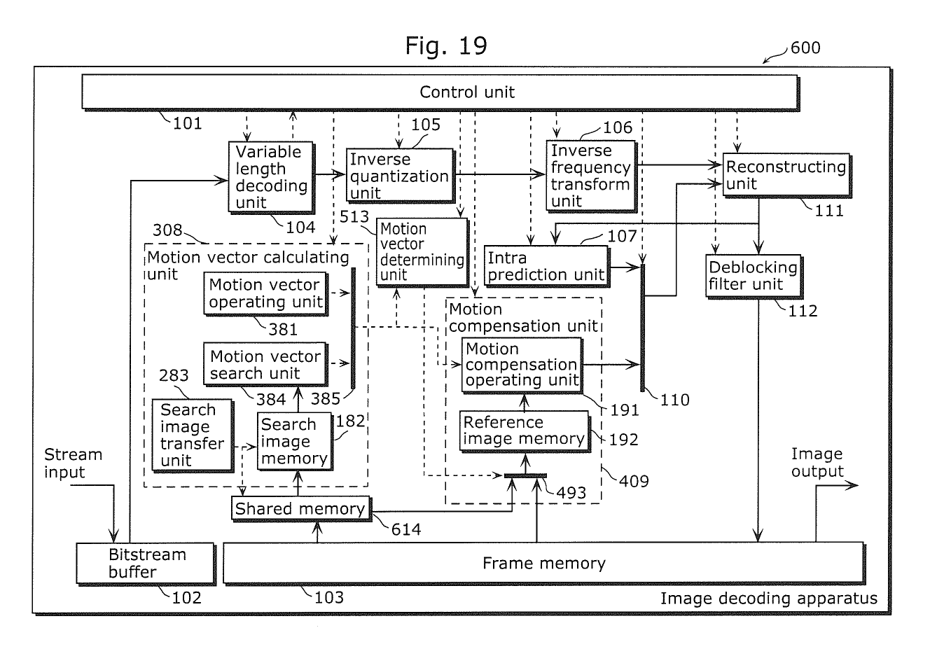

Next, the structure of the image decoding apparatus 600 in Embodiment 9 is described. FIG. 19 is a diagram showing a structure of the image decoding apparatus 600 in Embodiment 9. The image decoding apparatus 600 in Embodiment 9 includes a shared memory 614 having a storage capacity larger than that of the search image memory 182. The other structural elements are the same as in FIG. 17 in Embodiment 8. Thus, the same reference signs are assigned thereto and the same descriptions thereof are not repeated.

More specifically, the image decoding apparatus 600 according to Embodiment 9 includes: a search image memory (search area memory unit) 182 which is directly accessed by the motion vector search unit 384; and a shared memory 614 (a wide area memory unit 614) which stores the pixel data of an area that includes the search area stored in said search area memory unit and is wider than the search area in the reference image. The switch 493 transfers the pixel data in the reference area from the shared memory 614 to the reference image memory 192.

The outline of the image decoding apparatus 600 in Embodiment 9 has been described above.

Next, the image decoding apparatus 600 shown in FIG. 19 performs basically the same operations as in FIG. 13 that shows a flowchart of processes performed in Embodiment 6. However, it performs a search image transfer (S400) and a reference image transfer (S409) different from those in FIG. 13. In Embodiment 9, as in the earlier described Embodiments 1 to 7, processing performed on processing targets other than direct-mode targets is the same as processing in the H.264 Standard, and the operation method shown in NPL 3 is employed for the direct-mode targets.

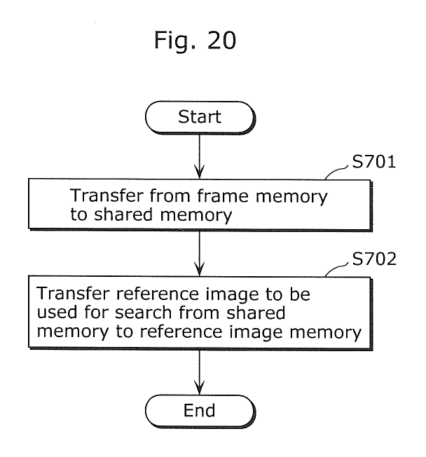

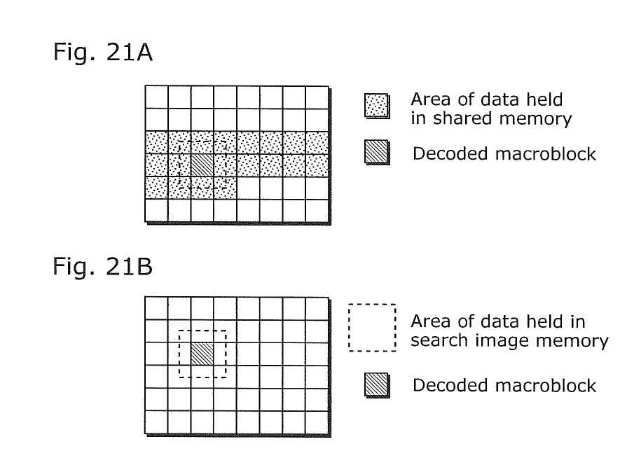

First, the operations of search image transfer (S400) in FIG. 13 are described with reference to the flowchart shown in FIG. 20. The search image transfer unit 283 transfers the pixel data in a search area from the frame memory 103 to the shared memory 614 (S701). As shown in FIG. 21A, the shared memory 614 holds the whole area that is also used in the search for the macroblock located immediately below. For this reason, the shared memory 614 needs to have a capacity in proportion to the horizontal size of the corresponding image.

Next, the search image transfer unit 283 transfers only the pixel data of the search area to be used by the motion vector search unit 384 from the shared memory 614 to the search image memory 182 (S702). As shown in FIG. 21B, the search image memory 182 holds only the search area required for the macroblock, and thus it is possible to reduce the capacity of the search image memory 182.

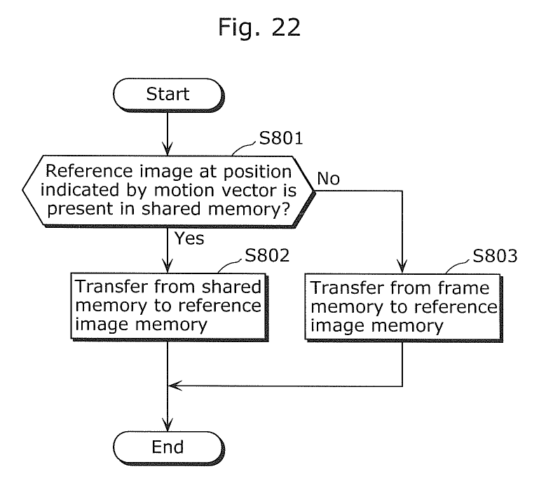

Next, the operations of reference image transfer (S409) in FIG. 13 are described with reference to the flowchart shown in FIG. 22. As shown in FIG. 22, the motion vector determining unit 513 determines whether the reference image (that is, the reference area) indicated by the motion vector calculated by the motion vector calculating unit 308 is present in the shared memory 614 or not (S801). When the reference image is present in the shared memory 614 (Yes in S801), the reference image is transferred from the shared memory 614 to the reference image memory 192 by the switch 493 (S802). The motion vector determining unit 513 always determines that the reference image is present in the shared memory 614 in the case of the direct mode.

On the other hand, when the motion vector determining unit 513 determines that the reference image is not present in the shared memory 614 (No in S801), the reference image is transferred from the frame memory 103 to the reference image memory 192.

The other processes are the same as in Embodiment 8, and thus the same descriptions are not repeated.

The operations performed by the image decoding apparatus 600 in Embodiment 9 have been described above.

With this configuration, it is only necessary for the search image memory 182 to respond to reading from the motion vector search unit 384 that makes a large amount of access and writing from the shared memory 614, and thus the configuration of the search image memory 182 is simplified.

Embodiment 9 has been described with respect to Embodiment 8, but it is to be noted that Embodiment 9 is also applicable to Embodiment 7.

The direct mode used in Embodiment 9 includes skip mode etc. that substantially uses the direct mode.

In addition, in Embodiment 9, the processing performed on processing targets other than direct-mode targets is the same as processing in the H.264 Standard, but other image coding standards such as the MPEG-2 Standard, the MPEG-4 Standard, the VC-1 Standard, and the like are possible. Alternatively, any other method is possible as long as the method supports plural direct modes and one of these is for calculating a motion vector by using pixel data of a reference image stored in a frame memory 103 as shown in NPL 3 cited in Embodiment 9.

Although the method of NPL 3 is used in Embodiment 9, any other method is possible as long as the method is for calculating a motion vector by using pixel data of a reference image stored in the frame memory 103. In addition, motion vector search ranges and accuracies are not limited to those in Embodiment 9, and may be determined freely. In the case where adjacent pixels are required to calculate the sub-pixel accuracy positions when motion vector search is performed, the data of the required pixels may be stored in the search image memory 182.

Each of the processing units may be implemented as a circuit by exclusive hardware, or as a program on a processor.

In addition, the search image memory 182 and the reference image memory 192 are memories, but any other data storage elements such as flip-flops are possible. Alternatively, the search image memory 182 and the reference image memory 192 may be configured as parts of a memory area in a processor or as parts of a cache memory.

In Embodiment 9, a reference image is transferred from the shared memory 614 to the reference image memory 192. However, it is also good that the motion compensation operating unit 191 directly accesses the search memory 614, reads out the reference image, and perform motion compensation.

### Embodiment 10

The processing described each of the embodiments can be simply implemented by an independent computer system, by recording, in a recording medium, a program for implementing the configurations for the image decoding method described in each of the embodiments. The recording medium may be any recording medium as long as the program can be recorded, such as a magnetic disk, an optical disk, a magnetic optical disk, an IC card, and a semiconductor memory.

Hereinafter, the applications to the image decoding method described in each of the embodiments and systems using thereof will be described.

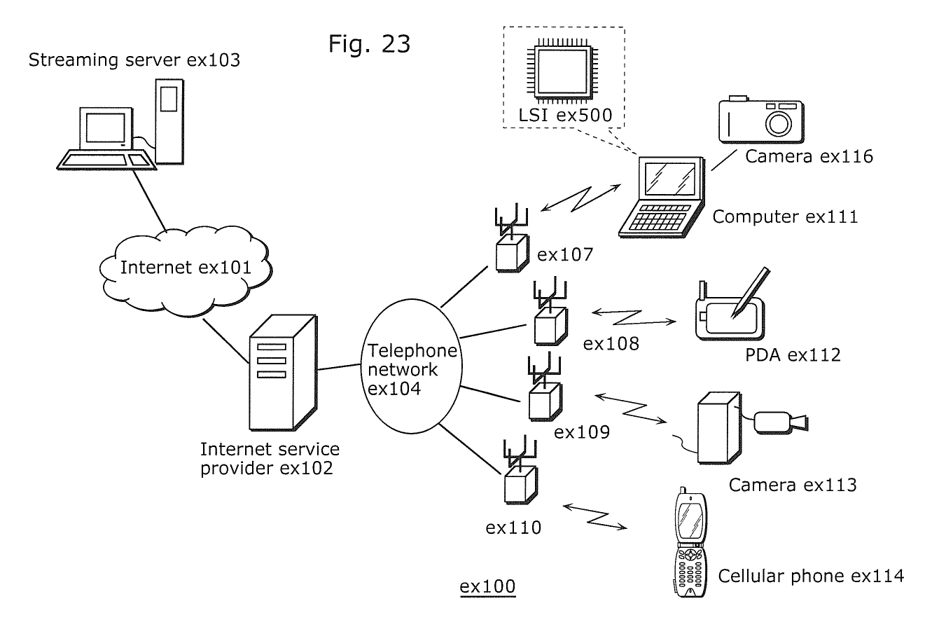

FIG. 23 illustrates an overall configuration of a content providing system ex100 for implementing content distribution services. The area for providing communication services is divided into cells of desired size, and base stations ex106 to ex110 which are fixed wireless stations are placed in each of the cells.

The content providing system ex100 is connected to devices, such as a computer ex111, a personal digital assistant (PDA) ex112, a camera ex113, a cellular phone ex114 and a game machine ex115, via an Internet ex101, an Internet service provider ex102, a telephone network ex104, as well as the base stations ex106 to ex110.

However, the configuration of the content providing system ex100 is not limited to the configuration shown in FIG. 23, and a combination in which any of the elements are connected is acceptable. In addition, each of the devices may be directly connected to the telephone network ex104, rather than via the base stations ex106 to ex110 which are the fixed wireless stations. Furthermore, the devices may be interconnected to each other via a short distance wireless communication and others.

The camera ex113, such as a digital video camera, is capable of capturing moving images. A camera ex116, such as a digital video camera, is capable of capturing both still images and moving images. Furthermore, the cellular phone ex114 may be the one that meets any of the standards such as Global System for Mobile Communications (GSM), Code Division Multiple Access (CDMA), Wideband-Code Division Multiple Access (W-CDMA), Long Term Evolution (LTE), and High Speed Packet Access (HSPA). Alternatively, the cellular phone ex114 may be a Personal Handyphone System (PHS).

In the content providing system ex100, a streaming server ex103 is connected to the camera ex113 and others via the telephone network ex104 and the base station ex109, which enables distribution of a live show and others. For such a distribution, a content (for example, video of a music live show) captured by the user using the camera ex113 is coded as described above in Embodiment 1, and the coded content is transmitted to the streaming server ex103. On the other hand, the streaming server ex103 carries out stream distribution of the received content data to the clients upon their requests. The clients include the computer ex111, the PDA ex112, the camera ex113, the cellular phone ex114, and the game machine ex115 that are capable of decoding the above-mentioned coded data. Each of the devices that have received the distributed data decodes and reproduces the coded data.

The captured data may be coded by the camera ex113 or the streaming server ex103 that transmits the data, or the coding processes may be shared between the camera ex113 and the streaming server ex103. Similarly, the distributed data may be decoded by the clients or the streaming server ex103, or the decoding processes may be shared between the clients and the streaming server ex103. Furthermore, the data of the still images and moving images captured by not only the camera ex113 but also the camera ex116 may be transmitted to the streaming server ex103 through the computer ex111. The coding processes may be performed by the camera ex116, the computer ex111, or the streaming server ex103, or shared among them.

Furthermore, the coding and decoding processes may be performed by an LSI ex500 generally included in each of the computer ex111 and the devices. The LSI ex500 may be configured of a single chip or a plurality of chips. Software for coding and decoding images may be integrated into some type of a recording medium (such as a CD-ROM, a flexible disk, a hard disk) that is readable by the computer ex111 and others, and the coding and decoding processes may be performed using the software. Furthermore, when the cellular phone ex114 is equipped with a camera, the moving image data obtained by the camera may be transmitted. The video data is data coded by the LSI ex500 included in the cellular phone ex114.

Furthermore, the streaming server ex103 may be composed of servers and computers, and may decentralize data and process the decentralized data, record, or distribute data.

As described above, the clients can receive and reproduce the coded data in the content providing system ex100. In other words, the clients can receive and decode information transmitted by the user, and reproduce the decoded data in real time in the content providing system ex100, so that the user who does not have any particular right and equipment can implement personal broadcasting.

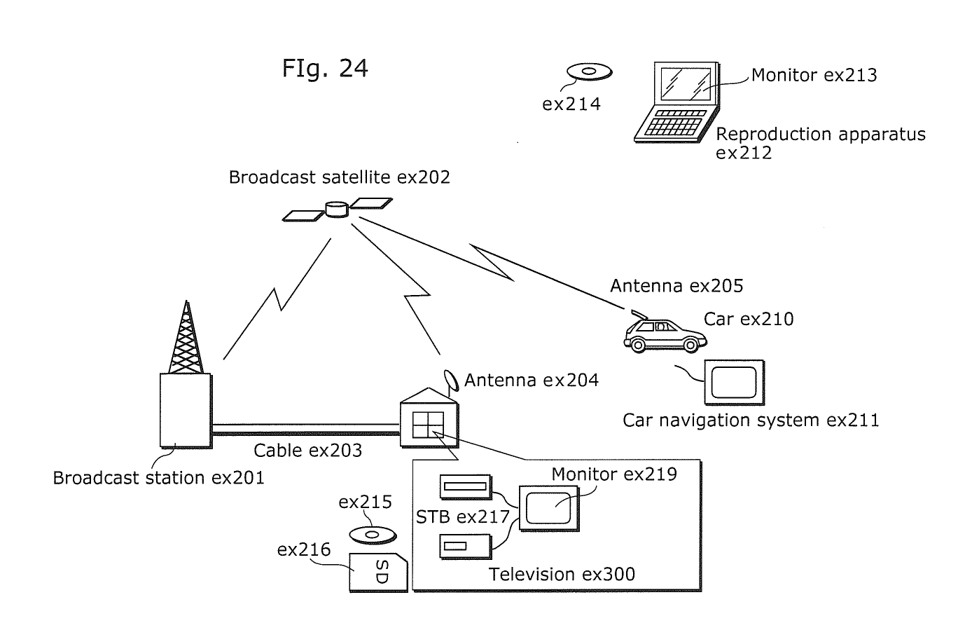

It is to be noted that at least one of the image coding apparatuses and image decoding apparatuses in the above-described embodiments can be incorporated also in a digital broadcasting system ex200 as shown in FIG. 24, in addition to the example of the content providing system ex100. More specifically, in a broadcasting station ex 201, a bitstream representing video information is communicated through electric waves or transmitted to a broadcasting satellite ex202. The bitstream is a bitstream coded according to one of the moving image coding methods described in the respective embodiments. The broadcasting satellite ex202 that received the bitstream transmits electric waves for broadcasting. The transmitted electric waves are received by an antenna ex 204 that is in a home and is capable of receiving the electric waves. The received bitstream is decoded and reproduced by a device that is a television (receiver) ex300, a set top box (STB) ex217, or the like.

In addition, it is possible to mount the image decoding apparatus shown in each of the above-described embodiments onto a reproduction apparatus ex212 which reads out and decodes the bitstream recorded in a storage medium ex214 that is a recording medium such as a CD, a DVD etc. In this case, the reproduced video signal is displayed on a monitor ex213.

Furthermore, it is possible to mount the image decoding apparatus or image coding apparatus shown in the above-described embodiments also onto a reader/recorder ex218 which either reads and decodes the coded bitstream recorded on a recording medium ex215 such as a DVD, a BD, etc. or codes and writes the video signal onto the recording medium ex215. In these cases, it is possible to display the reproduced video signal on a monitor ex219, and reproduce the video signal in other apparatuses and systems, by using the recording medium ex215 on which the coded bitstream is recorded. Furthermore, it is possible to mount one of the moving image decoding apparatuses in the set top box ex217 connected to either a cable ex203 for cable television or an antenna ex204 for satellite/terrestrial broadcasting, thereby displaying the video signal on the monitor ex219 of the television. It is also good to incorporate the moving image decoding apparatus in the television, instead of the set top box.

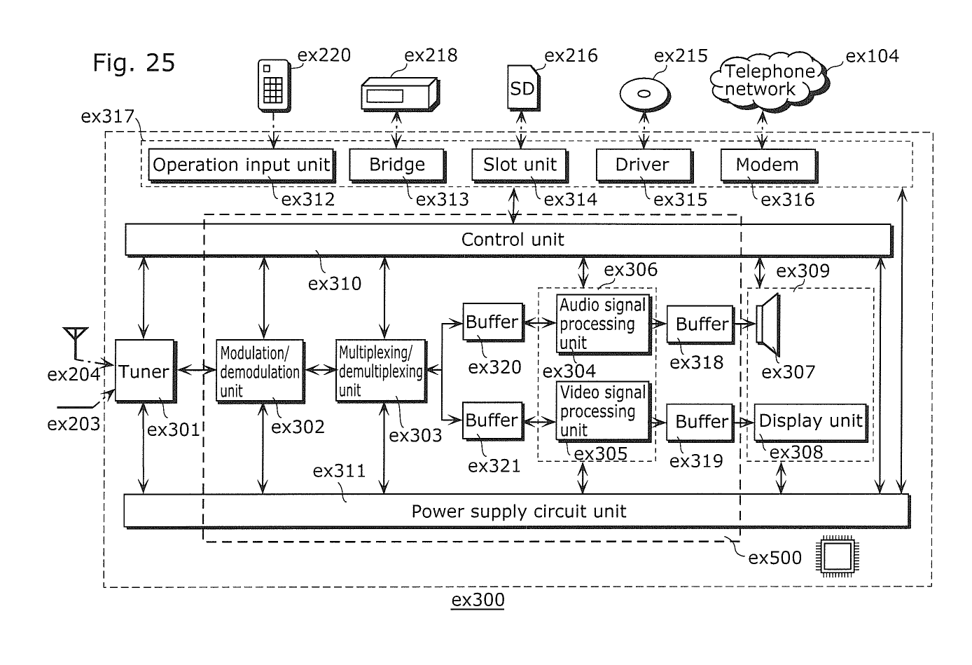

FIG. 25 illustrates the television (receiver) ex300 that uses the image decoding method described each of the embodiments. The television ex300 includes: a tuner ex301 that obtains or provides a bitstream of video information from and through the antenna ex204 or the cable ex203, etc. that receives a broadcast; a modulation/demodulation unit ex302 that demodulates the received coded data or modulates data into coded data to be supplied outside; and a multiplexing/demultiplexing unit ex303 that demultiplexes the modulated data into video data and audio data, or multiplexes the coded video data and audio data into data. The television ex300 further includes: a signal processing unit ex306 including an audio signal processing unit ex304 and a video signal processing unit ex305 that decode audio data and video data and code audio data and video data, respectively; a speaker ex307 that provides the decoded audio signal; and an output unit ex309 including a display unit ex308 that displays the decoded video signal, such as a display. Furthermore, the television ex300 includes an interface unit ex317 including an operation input unit ex312 that receives an input of a user operation. Furthermore, the television ex300 includes a control unit ex310 that controls overall each constituent element of the television ex300, and a power supply circuit unit ex311 that supplies power to each of the elements. Other than the operation input unit ex312, the interface unit ex317 may include: a bridge ex313 that is connected to an external device, such as the reader/recorder ex218; a slot unit ex314 for enabling attachment of the recording medium ex216, such as an SD card; a driver ex315 to be connected to an external recording medium, such as a hard disk; and a modem ex316 to be connected to a telephone network. Here, the recording medium ex216 can electrically record information using a non-volatile/volatile semiconductor memory element for storage. The constituent elements of the television ex300 are connected to each other through a synchronous bus.

First, a configuration will be described in which the television ex300 decodes data obtained from outside through the antenna ex204 and others and reproduces the decoded data. In the television ex300, upon receipt of a user operation from a remote controller ex220 and others, the multiplexing/demultiplexing unit ex303 demultiplexes the video data and audio data demodulated by the modulation/demodulation unit ex302, under control of the control unit ex310 including a CPU. Furthermore, the audio signal processing unit ex304 decodes the demultiplexed audio data, and the video signal processing unit ex305 decodes the demultiplexed video data, using the decoding method described in each of the embodiments, in the television ex300. The output unit ex309 provides the decoded video signal and audio signal outside, respectively. When the output unit ex309 provides the video signal and the audio signal, the signals may be temporarily stored in buffers ex318 and ex319, and others so that the signals are reproduced in synchronization with each other. Furthermore, the television ex300 may read a coded bitstream not through a broadcast and others but from the recording media ex215 and ex216, such as a magnetic disk, an optical disk, and an SD card. Next, a configuration will be described in which the television ex300 codes an audio signal and a video signal, and transmits the data outside or writes the data on a recording medium. In the television ex300, upon receipt of a user operation from the remote controller ex220 and others, the audio signal processing unit ex304 codes an audio signal, and the video signal processing unit ex305 codes a video signal, under control of the control unit ex310 using the coding method as described in each of the embodiments. The multiplexing/demultiplexing unit ex303 multiplexes the coded video signal and audio signal, and provides the resulting signal outside. When the multiplexing/demultiplexing unit ex303 multiplexes the video signal and the audio signal, the signals may be temporarily stored in buffers ex320 and ex321, and others so that the signals are reproduced in synchronization with each other. Here, the buffers ex318 to ex321 may be plural as illustrated, or at least one buffer may be shared in the television ex300. Furthermore, data may be stored in a buffer other than the buffers ex318 to ex321 so that the system overflow and underflow may be avoided between the modulation/demodulation unit ex302 and the multiplexing/demultiplexing unit ex303, for example.

Furthermore, the television ex300 may include a configuration for receiving an AV input from a microphone or a camera other than the configuration for obtaining audio and video data from a broadcast or a recording medium, and may code the obtained data. Although the television ex300 can code, multiplex, and provide outside data in the description, it may be not capable of coding, multiplexing, and providing outside data but capable of only one of receiving, decoding, and providing outside data.

Furthermore, when the reader/recorder ex218 reads or writes a coded bitstream from or in a recording medium, one of the television ex300 and the reader/recorder ex218 may decode or code the coded bitstream, and the television ex300 and the reader/recorder ex218 may share the decoding or coding.

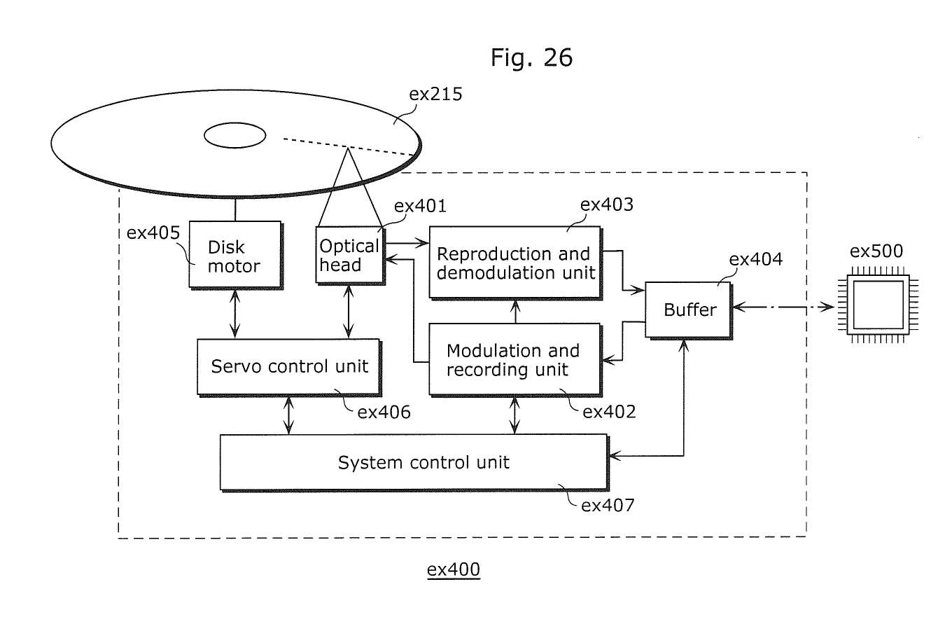

As an example, FIG. 26 illustrates a configuration of an information reproducing/recording unit ex400 when data is read or written from or in an optical disk. The information reproducing/recording unit ex400 includes constituent elements ex401 to ex407 to be described hereinafter. The optical head ex401 irradiates a laser spot on a recording surface of the recording medium ex215 that is an optical disk to write information, and detects reflected light from the recording surface of the recording medium ex215 to read the information. The modulation recording unit ex402 electrically drives a semiconductor laser included in the optical head ex401, and modulates the laser light according to recorded data. The reproduction demodulating unit ex403 amplifies a reproduction signal obtained by electrically detecting the reflected light from the recording surface using a photo detector included in the optical head ex401, and demodulates the reproduction signal by separating a signal component recorded on the recording medium ex215 to reproduce the necessary information. The buffer ex404 temporarily holds the information to be recorded on the recording medium ex215 and the information reproduced from the recording medium ex215. A disk motor ex405 rotates the recording medium ex215. A servo control unit ex406 moves the optical head ex401 to a predetermined information track while controlling the rotation drive of the disk motor ex405 so as to follow the laser spot. The system control unit ex407 controls overall the information reproducing/recording unit ex400. The reading and writing processes can be implemented by the system control unit ex407 using various information stored in the buffer ex404 and generating and adding new information as necessary, and by the modulation recording unit ex402, the reproduction demodulating unit ex403, and the servo control unit ex406 that record and reproduce information through the optical head ex401 while being operated in a coordinated manner. The system control unit ex407 includes, for example, a microprocessor, and executes processing by causing a computer to execute a program for read and write.

Although the optical head ex401 irradiates a laser spot in the description, it may perform high-density recording using near field light.

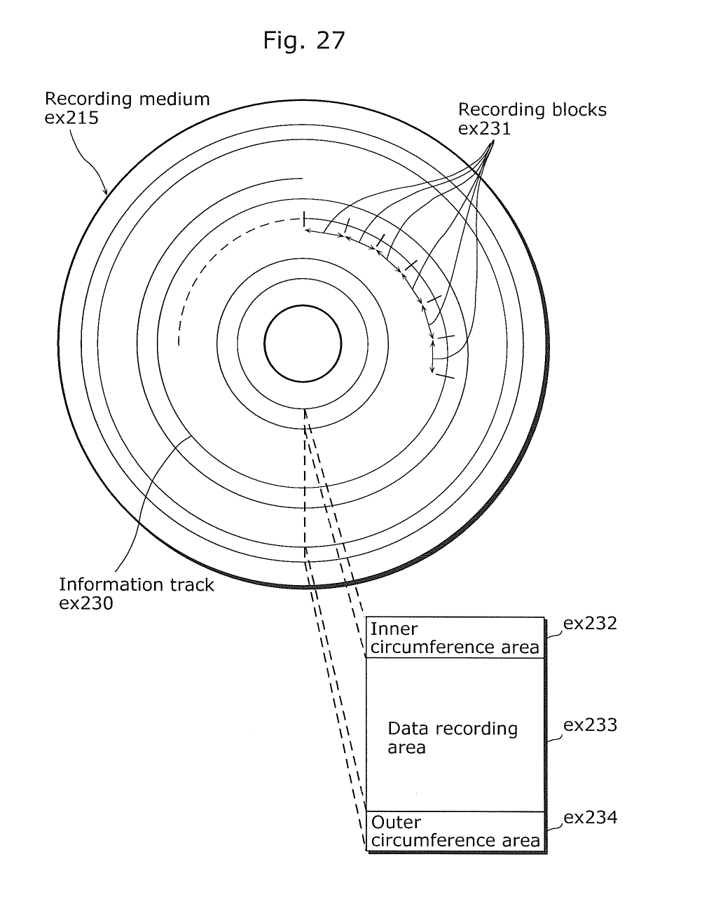

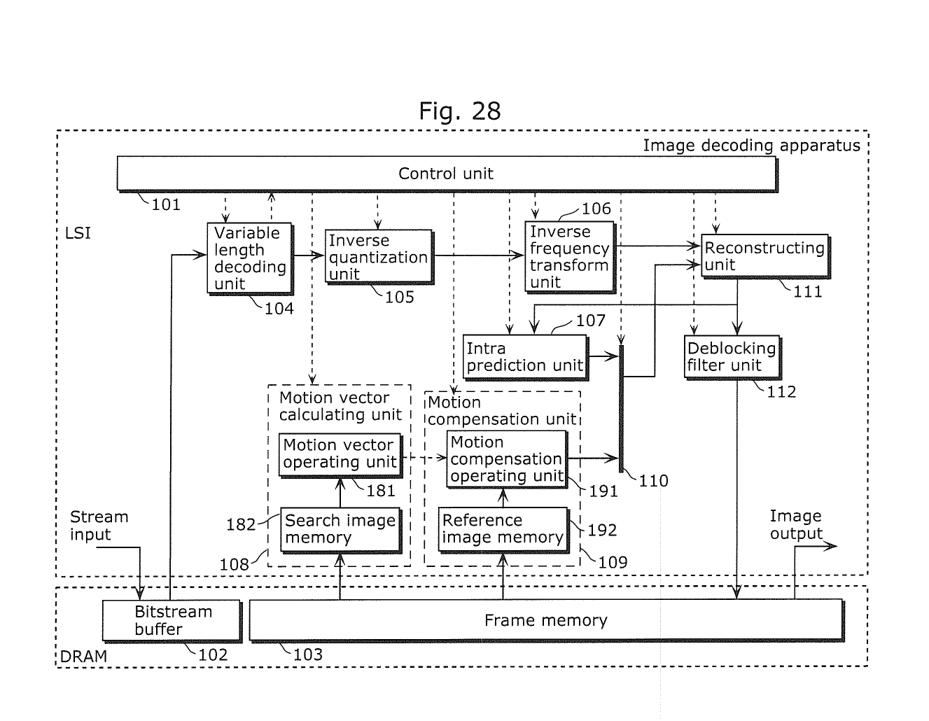

FIG. 27 schematically illustrates the recording medium ex215 that is the optical disk. On the recording surface of the recording medium ex215, guide grooves are spirally formed, and an information track ex230 records, in advance, address information indicating an absolute position on the disk according to change in a shape of the guide grooves. The address information includes information for determining positions of recording blocks ex231 that are a unit for recording data. An apparatus that records and reproduces data reproduces the information track ex230 and reads the address information so as to determine the positions of the recording blocks. Furthermore, the recording medium ex215 includes a data recording area ex233, an inner circumference area ex232, and an outer circumference area ex234. The data recording area ex233 is an area for use in recording the user data. The inner circumference area ex232 and the outer circumference area ex234 that are inside and outside of the data recording area ex233, respectively are for specific use except for recording the user data. The information reproducing/recording unit 400 reads and writes coded audio data, coded video data, or coded data obtained by multiplexing the coded audio data and the coded video data, from and on the data recording area ex233 of the recording medium ex215.

Although an optical disk having a layer, such as a DVD and a BD is described as an example in the description, the optical disk is not limited to such, and may be an optical disk having a multilayer structure and capable of being recorded on a part other than the surface. Furthermore, the optical disk may have a structure for multidimensional recording/reproduction, such as recording of information using light of colors with different wavelengths in the same portion of the optical disk and recording information having different layers from various angles.

Furthermore, a car ex210 having a antenna ex205 can receive data from the satellite ex202 and others, and reproduce video on the display device such as a car navigation system ex211 set in the car ex210, in the digital broadcasting system ex200. Here, a configuration of the car navigation system ex211 will be a configuration, for example, including a GPS receiving unit from the configuration illustrated in FIG. 25. The same will be true for the configuration of the computer ex111, the cellular phone ex114, and others. Furthermore, similarly to the television ex300, a terminal such as the cellular phone ex114 may have 3 types of implementation configurations including not only (i) a transmitting and receiving terminal including both a coding apparatus and a decoding apparatus, but also (ii) a transmitting terminal including only a coding apparatus and (iii) a receiving terminal including only a decoding apparatus.

In this way, the moving picture coding methods or moving picture decoding methods shown in the embodiments can be used in any of the aforementioned devices and systems, thereby making it possible to achieve the same advantageous effects described in the respective embodiments.

In addition, the present invention is not limited to these embodiments, and many variations of the embodiments and many modifications to the embodiments are possible without materially departing from the scope of the present invention.

### Embodiment 11

In this embodiment, FIG. 28 shows an embodiment in which the image decoding apparatus shown in Embodiment 1 is implemented as an LSI that is typically a semiconductor integrated circuit. Here, a bitstream buffer 102 and a frame memory 103 are formed on DRAMs, and the other circuits and memories are formed on an LSI.

The constituent elements configuring a corresponding one of the apparatuses may be made as separate individual chips, or as a single chip to include a part or all thereof. The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. It is also possible to use a Field Programmable Gate Array (FPGA) that is programmable after the LSI is manufactured, and a reconfigurable processor in which connections and settings of circuit cells within the LSI are reconfigurable.

In the future, with advancement in semiconductor technology, a brand-new technology may replace LSI. The functional blocks can be integrated using such a technology. Biotechnology is anticipated to apply.

Furthermore, it is possible to configure rendering devices for various applications, by combining a semiconductor chip on which the image decoding apparatus according to an embodiment of the present invention is integrated and a display for rending images. The present invention is applicable as information rendering units in mobile phones, television (receivers), digital video recorders, digital video cameras, car navigation systems, etc. Examples of displays that can be combined include Braun tubes (CRTs), liquid crystals, PDPs (plasma display panels), flat displays such as organic ELs, projector displays represented by projectors.

In addition, although this embodiment shows the configuration of an system LSI and DRAMs (dynamic random access memories), but may be configured in other storage devices such as eDRAMs (embedded DRAMs), SRAMs (static random access memories), and hard disks.

### Embodiment 12

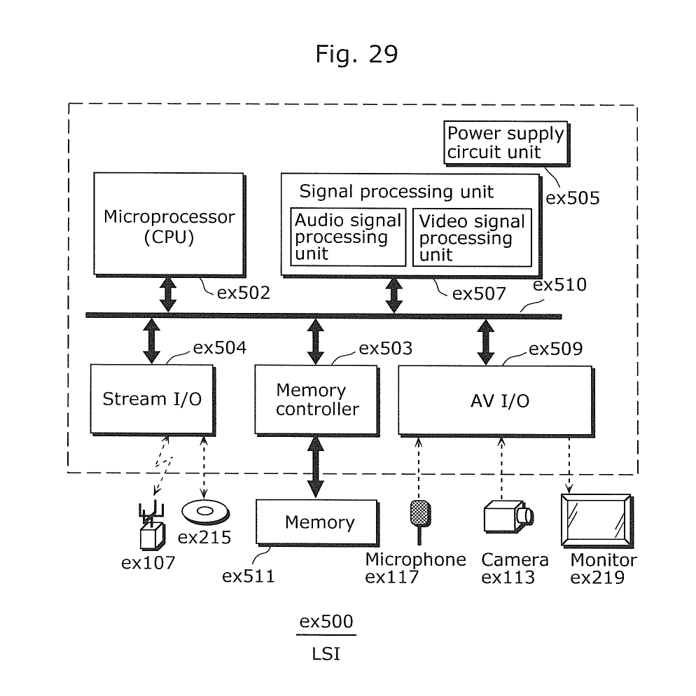

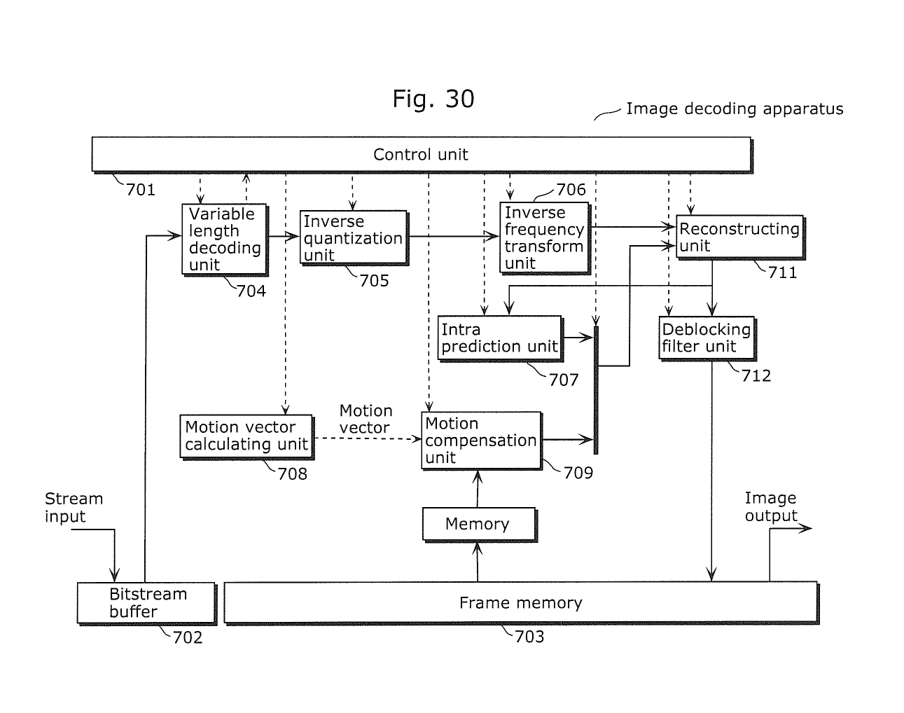

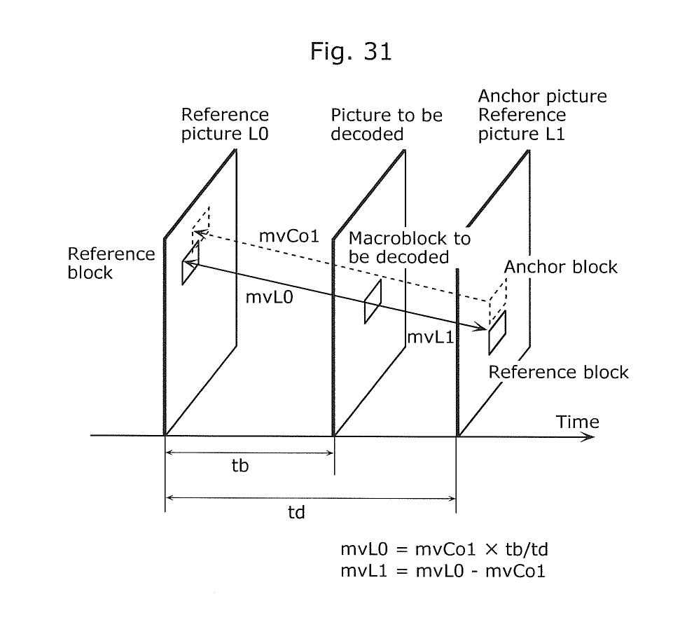

Each of the image decoding apparatuses and the image decoding methods in each of the embodiments is typically achieved in the form of an integrated circuit or a Large Scale Integrated (LSI) circuit. As an example of the LSI, FIG. 29 illustrates a configuration of the LSI ex500 that is made into one chip. The LSI ex500 includes elements ex502 to ex509 to be described below, and the elements are connected to each other through a bus ex510. A power supply circuit unit ex505 is activated by supplying each of the elements with power when power is on.

For example, when performing a decoding process, the LSI ex500 saves, in a memory ex511 or the like, coded data obtained by the stream I/O ex506 from the base station ex107 or coded data read out from the recording medium ex215, under control of the CPU ex502. Under the control of CPU ex502, the stored data is transmitted to the signal processing unit ex507, for example, in the form of segments that are units of separate transmission according to the processing amount, processing speed, and the like. Here, the video signal decoding process is the decoding process described in each of the above embodiments. Furthermore, depending on cases, it is good to save, in the memory ex511 or the like a decoded audio signal and a decoded video signal such that these signals can be reproduced in synchronization with each other. The decoded output signal is output from the AV I/O ex509 to the monitor ex219 or the like, after being stored in the memory ex511 or the like. In this configuration, the decoded output signal in the memory ex511 is accessed by using the memory controller ex503.

Although the memory ex511 is an element outside the LSI ex500 in the above description, it may be included in the LSI ex500. Furthermore, the LSI ex500 may be made into one chip or a plurality of chips.

The name used here is LSI, but it may also be called IC, system LSI, super LSI, or ultra LSI depending on the degree of integration.

Moreover, ways to achieve integration are not limited to the LSI, and a special circuit or a general purpose processor and so forth can also achieve the integration. A Field Programmable Gate Array (FPGA) that is programmable after manufacturing an LSI or a reconfigurable processor allowing re-configuration of the connection or configuration of an LSI can be used for the same purpose.

In the future, with advancement in semiconductor technology, a brand-new technology may replace LSI. The functional blocks can be integrated using such a technology. One such possibility is that the present invention is applied to biotechnology.

### INDUSTRIAL APPLICABILITY

Image decoding apparatuses according to the present invention can be applied to various applications. For example, the present invention can be applied to information display devices and imaging devices such as television sets, digital video decoders, car navigation systems, mobile phones, digital cameras, digital video cameras and the like.

### REFERENCE SIGNS LIST

20 First memory unit
30 Second memory unit
40 Search area transfer unit
50 Motion vector operating unit
60 Decoding unit
100, 200, 300, 400, 500, 600 Image decoding apparatus
101, 701 Control unit
102, 702 Bitstream buffer
103, 703 Frame memory
104, 704 Variable length decoding unit
105, 705 Inverse quantization unit
106, 706 Inverse frequency transform unit
107, 707 Intra prediction unit
108, 208, 308, 708 Motion vector calculating unit
109, 409, 709 Motion compensation unit
110, 385, 493 Switch
111, 711 Reconstructing unit
112, 712 Deblocking filter unit
181, 381 Motion vector operating unit
182 Search image memory
191 Motion compensation operating unit
192 Reference image memory
283 Search image transfer unit
384 Motion vector search unit
513 Motion vector determining unit
614 Shared memory
ex100 Content providing system
ex101 Internet
ex102 Internet service provider
ex103 Streaming server
ex104 Telephone network
ex106 Base station
ex107 Base station
ex108 Base station
ex109 Base station
ex110 Base station
ex111 Computer
ex112 PDA (Personal Digital Assistant)
ex113 Camera
ex114 Cellular phone
ex115 Game machine
ex116 Camera
ex117 Microphone
ex200 Digital broadcasting system
ex201 Broadcast station
ex202 Broadcast satellite
ex203 Cable
ex204 Antenna
ex205 Antenna
ex210 Car
ex211 Car navigation system
ex212 Reproduction apparatus
ex213 Monitor
ex215 Recording media
ex216 Recording media
ex217 Set top box
ex218 Reader/Recorder
ex219 Monitor
ex220 Remote controller
ex230 Information track
ex231 Recording block
ex232 Inner circumference area
ex233 Data recording area
ex234 Outer circumference area
ex300 Television (Receiver)
ex301 Tuner
ex302 Modulation/Demodulation unit
ex303 Multiplexing/Demultiplexing unit
ex304 Audio signal processing unit
ex305 Video signal processing unit
ex306 Signal processing unit
ex307 Speaker
ex308 Display unit
ex309 Output unit
ex310 Control unit
ex311 Power supply circuit unit
ex312 Operation input unit
ex313 Bridge
ex314 Slot unit
ex315 Driver
ex316 Modem
ex317 Interface unit
ex318 Buffer
ex319 Buffer
ex400 Information reproducing/recording unit
ex401 Optical head
ex402 Modulation recording unit
ex403 Reproduction demodulating unit
ex404 Buffer
ex405 Disk motor
ex406 Servo control unit
ex407 System control unit
ex500 LSI
ex502 CPU
ex503 Memory controller
ex505 Power supply circuit unit
ex506 Stream I/O
ex507 Signal processing unit
ex509 AV I/O
ex510 Bus
ex511 Memory

1. A decoding apparatus which decodes a block included in a coded image, said decoding apparatus comprising:
a first memory unit configured to store pixel data of a reference image that is an image already decoded by said decoding apparatus and is referred to when the block is decoded;
a second memory unit which has a storage capacity smaller than a storage capacity of said first memory unit and provides a data reading speed faster than data reading speed provided by said first memory unit;
a search area transfer unit configured to transfer, from said first memory unit to said second memory unit, pixel data in a search area that is a part of the reference image and required to calculate a motion vector for the block;
a motion vector operating unit configured to calculate the motion vector for the block by repeatedly (i) reading out, from said second memory unit, the pixel data in the search area for the block and (ii) performing a predetermined operation on the pixel data;
a motion compensation operating unit configured to generate a prediction image for the block by using the motion vector and the pixel data in the reference image;
a third memory unit configured to store pixel data of a reference area that is a part of the reference image and is referred to by said motion compensation operating unit;
a reference area transfer unit configured to transfer the pixel data in the reference area from one of said first and second memory units to said third memory unit; and
a decoding unit configured to decode the block using the prediction image generated by said motion compensation operating unit.

2. The decoding apparatus according to claim 1,
wherein the block is either a first block coded without adding information indicating a motion vector to be used in decoding or a second block coded by adding information indicating a motion vector,
said search area transfer unit is configured to transfer the pixel data in the search area from said first memory unit to said second memory unit, only when the block to be decoded is the first block, and
said decoding unit is configured to decode the first block by using the motion vector calculated by said motion vector operating unit, and decode the second block using the added motion vector.

3. The decoding apparatus according to claim 1,
wherein the block is either a first block coded without adding information indicating a motion vector to be used in decoding or a second block coded by adding information indicating a motion vector,
said search area transfer unit is configured to start transferring the pixel data in the search area from said first memory unit to said second memory unit, before determining whether the block to be decoded is the first block or the second block, and said decoding unit is configured to decode the first block by using the motion vector calculated by said motion vector operating unit, and decode the second block by using the added motion vector.

4. The decoding apparatus according to claim 3,
wherein said search area transfer unit is configured to stop transfer of the pixel data in the search area from said first memory unit to said second memory unit, when the block to be decoded is the second block.

5. The decoding apparatus according to any one of claim 1,
wherein said second memory unit is configured to keep storing at least a part of previous pixel data transferred by said search area transfer unit, and
said search area transfer unit is configured to transfer only pixel data that has not yet been stored in said second memory unit among the pixel data in the search area, from said first memory unit to said second memory unit.

6. The decoding apparatus according to claim 5,
wherein said search area transfer unit is configured to delete, from said second memory unit, pixel data that is not used to calculate motion vectors for following blocks that make up the coded image from among previous pixel data.

7. The decoding apparatus according to claim 6,
wherein, in the case where blocks that make up the coded image are sequentially decoded from top left to bottom right of the coded image,
said search area transfer unit is configured to transfer pixel data in a part corresponding to a bottom right corner of the search area from said first memory unit to said second memory unit, and delete, from said second memory unit, pixel data transferred before pixel data in a part corresponding to a top left corner of the search area is transferred.

8. The decoding apparatus according to any one of claim 1,
wherein said search area transfer unit is configured to transfer pixel data in the search area corresponding to an (n+1)th block from said first memory unit to said second memory unit, in parallel with calculation of a motion vector of an nth block by said motion vector operating unit, n being a natural number, and the nth block and the (n+1)th block being included in blocks that make up the coded image.

9. (canceled)

10. The decoding apparatus according to claim 1,
wherein the block is either a first block coded without adding information indicating a motion vector to be used in decoding or a second block coded by adding information indicating a motion vector, and
said reference area transfer unit is configured to transfer pixel data in the reference area corresponding to the first block from said second memory unit to said third memory unit, and transfer pixel data in the reference image corresponding to the second block from said first memory unit to said third memory unit.

11. The decoding apparatus according to claim 10,
wherein said second memory unit includes:
a search area memory unit that is directly accessed by said motion vector operating unit; and
a wide area memory unit configured to store pixel data of an area that includes the search area stored in said search area memory unit and is wider than the search area in the reference image, and
said reference area transfer unit is configured to transfer pixel data in the reference area from said wide area memory unit to said third memory unit.

12. The decoding apparatus according to claim 1,
wherein said search area includes:
a first search area included in a preceding reference image that precedes, in display order, the coded image including the block; and
a second search area included in a succeeding reference image that succeeds, in display order, the coded image including the block, and
said motion vector operating unit is configured to:
repeatedly perform (i) reading out, from said second memory unit, pixel data in a search range in each of the first and second search areas, and (ii) calculating a sum of absolute differences, the (i) reading and (ii) calculating being performed by shifting a position of the search range within each of the first and second search areas; and
calculate the motion vector, based on the position that is of the search range and has a smallest sum of absolute differences.

13. A decoding method of decoding a block included in a coded image,
said decoding method being performed by a decoding apparatus including:
a first memory unit configured to store pixel data of a reference image that is an image already decoded by the decoding apparatus and is referred to when the block is decoded; and
a second memory unit which has a storage capacity smaller than a storage capacity of the first memory unit and provides a data reading speed faster than data reading speed provided by the first memory unit; and
a third memory unit,
said decoding method comprising:
transferring, from the first memory unit to the second memory unit, pixel data in a search area that is a part of the reference image and required to calculate a motion vector for the block;
calculating the motion vector for the block by repeatedly (i) reading out, from the second memory unit, the pixel data in the search area for the block and (ii) performing a predetermined operation on the pixel data;
generating a prediction image for the block by using the motion vector and the pixel data in the reference image;
transferring the pixel data in the reference area that is a part of the reference image and is referred to in said generating, from one of the first and second memory units to the third memory unit; and
decoding the block using the prediction image generated in said generating.

14. A non-transitory computer-readable recording medium on which a program causing a decoding apparatus to decode a block included in a coded image is recorded,
the decoding apparatus including:
a first memory unit configured to store pixel data of a reference image that is an image already decoded by the decoding apparatus and is referred to when the block is decoded; and
a second memory unit which has a storage capacity smaller than a storage capacity of the first memory unit and provides a data reading speed faster than data reading speed provided by the first memory unit; and
a third memory unit,
said program causing the decoding apparatus to execute:
transferring, from the first memory unit to the second memory unit, pixel data in a search area that is a part of the reference image and required to calculate a motion vector for the block;
calculating the motion vector for the block by repeatedly (i) reading out, from the second memory unit, the pixel data in the search area for the block and (ii) performing a predetermined operation on the pixel data;
generating a prediction image for the block by using the motion vector and the pixel data in the reference image;
transferring the pixel data in the reference area that is a part of the reference image and is referred to in said generating, from one of the first and second memory units to the third memory unit; and
decoding the block using the prediction image generated in said generating.

15. An integrated circuit which decodes a block included in a coded image,
said integrated circuit being included in a decoding apparatus which includes a first memory unit configured to store pixel data of a reference image that is an image already decoded by the decoding apparatus and is referred to when the block is decoded, and
said integrated circuit comprising:
a second memory unit which has a storage capacity smaller than a storage capacity of said first memory unit and provides a data reading speed faster than data reading speed provided by said first memory unit;
a search area transfer unit configured to transfer, from the first memory unit to said second memory unit, pixel data in a search area that is a part of the reference image and required to calculate a motion vector for the block;
a motion vector operating unit configured to calculate the motion vector for the block by repeatedly (i) reading out, from said second memory unit, the pixel data in the search area for the block and (ii) performing a predetermined operation on the pixel data;
a motion compensation operating unit configured to generate a prediction image for the block by using the motion vector and the pixel data in the reference image;
a third memory unit configured to store pixel data of a reference area that is a part of the reference image and is referred to by said motion compensation operating unit;
a reference area transfer unit configured to transfer the pixel data in the reference area from one of said first and second memory units to said third memory unit; and
a decoding unit configured to decode the block using the prediction image generated by said motion compensation operating unit.
